(19) United States
(12) Patent Application Publication
(10) Pub. No.: US 2025/0141040 A1
(43) Pub. Date: May 1, 2025

(54) BINDER FOR NON-AQUEOUS SECONDARY BATTERY SEPARATOR, RESIN COMPOSITION FOR NON-AQUEOUS SECONDARY BATTERY SEPARATOR, NON-AQUEOUS SECONDARY BATTERY SEPARATOR, NON-AQUEOUS SECONDARY BATTERY, ELECTRICITY STORAGE DEVICE AND BINDER, AQUEOUS DISPERSION, RESIN COMPOSITION AND SEPARATOR USED THEREFOR, AND METHOD FOR PREPARING BINDER

(71) Applicants: artience Co., Ltd., Tokyo (JP); TOYOCHEM CO., LTD., Tokyo (JP)

(72) Inventors: Yoshiyuki SAKAI, Chuo-ku, Tokyo (JP); Takaaki KOIKE, Chuo-ku, Tokyo (JP); Airei CHOU, Chuo-ku, Tokyo (JP); Daisuke FUJIKAWA, Chuo-ku, Tokyo (JP); Akiko IMAZATO, Chuo-ku, Tokyo (JP)

(73) Assignees: artience Co., Ltd., Tokyo (JP); TOYOCHEM CO., LTD., Tokyo (JP)

(21) Appl. No.: 18/683,635

(22) PCT Filed: Aug. 22, 2022
(86) PCT No.: PCT/JP2022/031528

§ 371 Date: Feb. 14, 2024

(30) Foreign Application Priority Data
Aug. 31, 2021 (JP) 2021-141623
Apr. 12, 2022 (JP) 2022-065757

(51) Int. Cl. H01M 50/414; H01M 50/403; H01M 50/446; H01M 50/449

(52) U.S. Cl. CPC H01M 50/414; H01M 50/403; H01M 50/446; H01M 50/449

(57) ABSTRACT

A binder for a non-aqueous secondary battery separator to form a non-aqueous secondary battery separator excellent in flexibility, etc. is provided. An electricity storage device having excellent long-term storage stability etc. is also provided. The binder for a non-aqueous secondary battery separator includes a polymer (A) of a monomer mixture including a monomer having an acidic functional group, a monomer having an amide group, and an alkyl (meth)acrylate monomer, and a condensation product of a silane compound, and has a glass transition temperature of −60° C. to 60° C. The electricity storage device has a separator substrate provided with at least one protective layer between a pair of electrodes, in which the protective layer includes a polymer of an ethylenically unsaturated monomer, and a silane compound, and the silane compound has no ethylenically unsaturated group but has an alkyl group having 3 to 12 carbon atoms.

### TECHNICAL FIELD

The present disclosure relates to a binder for non-aqueous secondary battery separator that can be used to form a protective layer in the separator of a non-aqueous secondary battery such as lithium ion secondary battery. Further, the present disclosure relates to a resin composition for a non-aqueous secondary battery separator containing such a binder for non-aqueous secondary battery separator, a non-aqueous secondary battery separator having a protective layer formed from a resin composition for a non-aqueous secondary battery separator, and a non-aqueous secondary battery having the non-aqueous secondary battery separator. The present disclosure also relates to an electricity storage device; a binder and an aqueous dispersion thereof, a resin composition and a separator used for the device; and a method for preparing the binder.

### BACKGROUND

Non-aqueous secondary batteries have a small size and light weight with high energy density, capable of being repeatedly charged and discharged, and therefore are used in various applications. Among them, lithium ion secondary batteries (hereinafter referred to as “LIB”) achieve a high output, and therefore are widely used in mobile applications such as notebook computers and smart phones. In recent years, LIBs have begun to be used in automobile applications.

An LIB includes, for example, a separator made of polyolefin to avoid electrical contact between the positive and negative electrodes, while allowing ions in an electrolytic solution to pass through. However, in the case where the LIB reaches high temperature, the separator made of polyolefin melts to short-circuit both of the electrodes, possibly causing explosion of the LIB. Therefore, in order to prevent the short circuit, the separator is generally provided with a protective layer mainly composed of inorganic filler.

As a binder for forming such a protective layer, Japanese Unexamined Patent Application Publication No. 2015-088484 discloses a binder for separators composed of polymer particles prepared by copolymerization of an acidic functional group-containing monomer, an amide group-containing monomer, and a monomer different from (meth)acrylonitrile, the polymer particles having a glass transition temperature of −60 to 60° C. Further, Japanese Unexamined Patent Application Publication No. 2012-221889 discloses use of a binder for separators composed of silane compound having an unsaturated bond as a constituent component.

Further, electricity storage devices such as lithium ion secondary batteries have a small size and light weight with high energy density, capable of being repeatedly charged and discharged, and therefore are used in various applications. These electricity storage devices generally include an electrically insulating separator having a porous structure between electrodes in order to ensure safety under an abnormal circumstance. Although the separator normally allows the movement of ions, the pores are closed to block the movement of ions when the temperature rises to high temperature under an abnormal circumstance, so that short circuiting of the electricity storage device can be prevented. As a separator, a polyolefin film such as polyethylene film and polypropylene film having a porous structure (generally referred to as “separator substrate”), and a separator substrate further provided with a protective layer formed of resin composition containing a binder resin and an electrically insulating inorganic filler are known. However, the resin composition for forming the protective layer is often inferior in storage stability (in many cases, the binder resin and the inorganic fillers aggregate). Therefore, even if the resin composition is redispersed to be applied to the separator substrate under high temperature conditions or after long-term storage, excellent separator characteristics (specifically, adhesion to the separator substrate and inorganic filler, resistance to electrolytic solution, heat resistance, etc.) are not stably exhibited. There is also a problem that an electricity storage device with use of the resin composition cannot achieve excellent performance.

In some cases, a silane compound is added to the protective layer for the purpose of improving the strength of the members used in electricity storage devices and the bonding between members. However, the deterioration of physical properties of a separator and the performance degradation of an electricity storage device are particularly prominent when a silane compound is included.

For example, Japanese Unexamined Patent Application Publication No. 2015-138770 discloses an electricity storage device including a laminate having a layer containing a thermoplastic polymer containing a copolymer having 7-methacryloxy propyltrimethoxysilane as monomer unit and a substrate for separator. Also, International Patent Publication No. WO2020-263936 and International Patent Publication No. WO2020-263937 disclose a separator coated with a layer containing an acrylic/fluorocopolymer modified with γ-methacryloxy propyltrimethoxysilane or tetraethyl orthosilicate. However, any of the inventions disclosed in the literature is an invention aimed at improving the adhesion between a separator and electrodes, and the other problems described above cannot be solved so far.

### SUMMARY

In recent years, the demand for high-capacity secondary batteries has increased further, and in order to increase the battery capacity per unit volume, there is a demand for thinner separators with a protective layer. Since the heat resistance of a separator generally tends to deteriorate as the film becomes thinner, an effect of imparting heat resistance to the protective layer of a separator is required more than ever. However, conventional binders for separators have difficulty in increasing the inorganic filler ratio in the protective layer due to insufficient adhesion to the separator substrate, so that the effect of improving the heat resistance of a thin film separator has been hardly satisfied.

Accordingly, the first object of the present disclosure is to provide a binder for a non-aqueous secondary battery separator to form a non-aqueous secondary battery separator excellent in flexibility, adhesion, resistance to electrolytic solution, and heat resistance; a resin composition for a non-aqueous secondary battery separator excellent in solution stability containing the binder for a non-aqueous secondary battery separator; a non-aqueous secondary battery separator provided with a protective layer formed of resin composition for a non-aqueous secondary battery separator; and a non-aqueous secondary battery having good cycle characteristics provided with the non-aqueous secondary battery separator. In particular, the binder for a non-aqueous secondary battery separator of the present disclosure has improved affinity with inorganic filler and excellent adhesion to a separator substrate, so that a separator with a protective layer having improved heat resistance can be provided even in the case where the protective layer is a thin film.

In other words, the present disclosure relates to a binder for a non-aqueous secondary battery separator, including a polymer (A) prepared by polymerization of a monomer mixture comprising a monomer (a1) having an acidic functional group, a monomer (a2) having an amide group, and an alkyl (meth)acrylate monomer (a3), and a condensation product (B) of a silane compound (b) represented by the following general formula (1), wherein the binder has a glass transition temperature of −60 to 60° C.

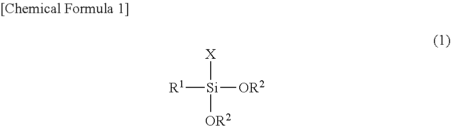

in which R¹ represents an alkyl group having 1 to 18 carbon atoms, a cycloalkyl group having 1 to 18 carbon atoms, or an aryl group having 1 to 18 carbon atoms, R² represent each independently a methyl group or an ethyl group, and X represents a methyl group, a methoxy group, or an ethoxy group.

The present disclosure also relates to a binder for a non-aqueous secondary battery separator, in which the acidic functional group of the monomer (a1) having an acidic functional group is any of a carboxyl group, a sulfonate group, or a phosphate group.

The present disclosure also relates to a binder for a non-aqueous secondary battery separator, in which the monomer mixture contains no monomer (a4) having a crosslinkable functional group.

The present disclosure also relates to a binder for a non-aqueous secondary battery separator, wherein the binder is in a particulate form and has an average particle size of 50 to 500 nm.

The present disclosure also relates to a binder for a non-aqueous secondary battery separator, in which the polymer (A) is obtained by emulsion polymerization of a monomer mixture in an aqueous medium in which the silane compound (b) is dissolved.

The present disclosure also relates to a resin composition for a non-aqueous secondary battery separator, including a binder for a non-aqueous secondary battery separator and an inorganic filler.

The present disclosure also relates to a non-aqueous secondary battery separator including a protective layer formed from a resin composition for a non-aqueous secondary battery separator on at least one surface of a separator substrate.

The present disclosure also relates to a non-aqueous secondary battery having a non-aqueous secondary battery separator, a positive electrode, and a negative electrode.

Further, the present disclosure relates to a method for preparing a binder for a non-aqueous secondary battery separator, including a step of emulsion polymerizing a monomer mixture in an aqueous medium in which a silane compound (b) represented by the following general formula (1) is dissolved, to thereby prepare a condensation product (B) of a silane compound (b) and a polymer (A), in which the monomer mixture contains a monomer (a1) having an acidic functional group, a monomer (a2) having an amide group, and an alkyl (meth)acrylate monomer (a3), and a glass transition temperature of the binder is −60 to 60° C.:

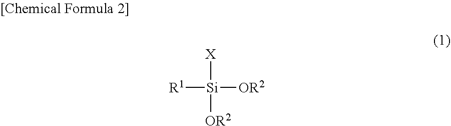

in which R¹ represents an alkyl group having 1 to 18 carbon atoms, a cycloalkyl group having 1 to 18 carbon atoms, or an aryl group having 1 to 18 carbon atoms, R² each independently represents a methyl group or an ethyl group, and X represents a methyl group, a methoxy group, or an ethoxy group.

According to the present disclosure, a binder for a non-aqueous secondary battery separator from which a non-aqueous secondary battery separator excellent in flexibility, adhesion, resistance to electrolytic solution and heat resistance can be formed, a resin composition for a non-aqueous secondary battery separator excellent in solution stability containing the binder for a non-aqueous secondary battery separator, a non-aqueous secondary battery separator provided with a protective layer formed from the resin composition for a non-aqueous secondary battery separator, and a non-aqueous secondary battery excellent in cycle characteristics including the non-aqueous secondary battery separator can be provided.

Further, a material for forming the protective layer is required to be transported and stored for a long time, and the requirements are important practical problems. Furthermore, characteristics of the separator and the electricity storage device are required not to deteriorate even after a long period storage of the material. Accordingly, a second object of the present disclosure is to provide a binder, an aqueous dispersion thereof, and a resin composition for forming a protective layer of a separator substrate of electricity storage devices, having excellent long-term storage stability to impart excellent characteristics of an electricity storage device and excellent characteristics of separators (flexibility, adhesion, resistance to electrolytic solution and heat resistance) even after long-term storage. Further, the object is to provide a separator and an electricity storage device having excellent characteristics.

In other words, the present disclosure relates to an electricity storage device having a separator substrate provided with at least one protective layer between a pair of electrodes, in which the protective layer includes a polymer (C) of an ethylenically unsaturated monomer (c), and a silane compound, and the silane compound has no ethylenically unsaturated group but has an alkyl group having 3 to 12 carbon atoms.

The present disclosure also relates to an electricity storage device, in which the silane compound includes a condensate (D) of an alkoxy monosilane compound (d) having no ethylenically unsaturated group but having an alkyl group having 3 to 12 carbon atoms.

The present disclosure also relates to an electricity storage device, in which a complete hydrolysate of the alkoxy monosilane compound (d) has an octanol/water partition coefficient (log Kow) of −1.5 to 6 at 25° C.

Further, the present disclosure also relates to an electricity storage device, in which the ethylenically unsaturated monomer (c) includes at least one selected from the group consisting of a monomer (c1) having an acidic group and a monomer (c2) having an amide group.

The present disclosure also relates to an electricity storage device, in which the protective layer further includes an inorganic filler.

Further, the present disclosure relates to a binder for forming a protective layer of an electricity storage device having a separator substrate provided with at least one protective layer between a pair of electrodes, the binder including a polymer (C) of an ethylenically unsaturated monomer (c), and a silane compound, in which the silane compound has no ethylenically unsaturated group but has an alkyl group having 3 to 12 carbon atoms.

Further, the present disclosure relates to an aqueous dispersion of binder for forming a protective layer of an electricity storage device having a separator substrate provided with at least one protective layer between a pair of electrodes, the aqueous dispersion of binder including a polymer (C) of an ethylenically unsaturated monomer (c), a silane compound, and an aqueous medium, in which the silane compound has no ethylenically unsaturated group but has an alkyl group having 3 to 12 carbon atoms.

Further, the present disclosure relates to a resin composition for forming the protective layer of an electricity storage device having a separator substrate provided with at least one protective layer between a pair of electrodes, the resin composition including a polymer (C) of an ethylenically unsaturated monomer (c), a silane compound, and an inorganic filler, in which the silane compound has no ethylenically unsaturated group but has an alkyl group having 3 to 12 carbon atoms.

Further, the present disclosure also relates to a separator for an electricity storage device having a separator substrate provided with at least one protective layer between a pair of electrodes, the separator including the separator substrate and at least one protective layer, in which the protective layer includes the polymer (C) of the ethylenically unsaturated monomer (c), and a silane compound, and the silane compound has no ethylenically unsaturated group but has an alkyl group having 3 to 12 carbon atoms.

According to the present disclosure, a binder, an aqueous dispersion thereof, and a resin composition for forming the protective layer of a separator substrate of electricity storage devices, having excellent long-term storage stability to impart excellent characteristics of electrical storage devices and excellent characteristics of separators (flexibility, adhesion, resistance to electrolytic solution and heat resistance) even after long-term storage can be provided. Further, a separator and an electricity storage device having excellent characteristics can be provided.

### BRIEF DESCRIPTION OF DRAWING

FIG. 1 is a vertical cross-sectional view showing an embodiment of an LIB of the present disclosure.

### DETAILED DESCRIPTION OF EMBODIMENTS

### Embodiment 1

Embodiments of a binder for a non-aqueous secondary battery separator, a resin composition for a non-aqueous secondary battery separator, a non-aqueous secondary battery separator, and a non-aqueous secondary battery that suitably achieve the first object of the present disclosure will be described as follows. However, the present disclosure is not so limited thereto. Each configuration may be replaced with any one that can exhibit a similar function, or an optional configuration can be added to each configuration.

In the present specification, a numerical range specified using “to” includes the numerical values at front and rear of “to” as the lower and upper limits of the range, respectively. Further, in the present specification, “film” and “sheet” are not distinguished by thickness.

The monomer means a monomer having an ethylenically unsaturated double bond, and a monomer (a1) having an acidic functional group, a monomer (a2) having an amide group, an alkyl (meth)acrylate monomer (a3), a monomer (a4) having a crosslinkable functional group, and a silane compound (b) represented by the general formula (1) may be referred to as monomer (a1), monomer (a2), monomer (a3), monomer (a4), and silane compound (b), respectively.

Unless otherwise noted, the various components described in the present specification may be each independently used alone or in combination of two or more.

The non-aqueous secondary battery is a secondary battery using no water as electrolytic solution, and examples thereof include an LIB, a sodium ion secondary battery, and a magnesium secondary battery. As described below, LIB is described as an example of non-aqueous secondary batteries in the specification. Needless to say, the binder for a non-aqueous secondary battery separator, the resin composition for a non-aqueous secondary battery separator, and the non-aqueous secondary battery separator of the present disclosure may be applied to non-aqueous secondary batteries other than LIB.

### (Binder for Non-Aqueous Secondary Battery Separator)

The binder for a non-aqueous secondary battery separator of the present disclosure has a glass transition temperature (Tg) of −60 to 60° C. and contains a polymer (A) and a condensation product (B). The polymer (A) is a polymer of monomer mixture including a monomer (a1) containing an acidic functional group, a monomer (a2) containing an amide group, and an alkyl (meth)acrylate monomer (a3), and the condensation product (B) is a condensate of the silane compound (b).

The condensation product (B) is localized near the surface of the polymer (A) due to hydrophobic interactions. As a result, the binder for a non-aqueous secondary battery separator made into a resin composition has drastically improved dispersibility when mixed with an inorganic filler, having more excellent adhesion to a separator substrate in comparison with conventional ones.

With a Tg of the binder of −60 to 60° C., the resin composition for a non-aqueous secondary battery separator has excellent resistance to electrolytic solution and improved adhesion to a separator substrate. Tg of the polymer (A) is preferably −50 to 50° C., more preferably −40 to 40° C. Thereby, the effect of adhesion to a separator substrate is further improved.

Tg of the binder is measured using a differential scanning calorimeter (DSC, manufactured by TA Instruments). Specifically, about 2 mg of a sample is weighed on an aluminum pan, the aluminum pan is set in a DSC measurement holder, and the baseline shift of the DSC curve obtained under a heating condition of 5° C./minute toward endothermic side (inflection point) is read to obtain Tg.

In particular, in the case where the polymer (A) is a polymer obtained by emulsion polymerization of a monomer mixture in an aqueous medium in which the silane compound (b) is dissolved, the condensation product (B) of the silane compound (b) is localized near the surface of the polymer (A) by hydrophobic interactions. As a result, the binder for a non-aqueous secondary battery separator has drastically improved dispersibility when mixed with an inorganic filler, having improved affinity with the inorganic filler so as to preferably exhibit more excellent adhesion to a separator substrate in comparison with conventional ones.

### <Polymer (A)>

The polymer (A) is a polymer of monomer mixture containing a monomer (a1) having an acidic functional group, a monomer (a2) having an amide group, an alkyl (meth)acrylate monomer (a3), and, if necessary, other monomers. It is preferable that the monomer mixture contain no monomer (a4) having a crosslinkable functional group.

Due to the presence of the amide group in the monomer (a2), the affinity between the polymer (A) and the inorganic filler is improved, resulting in excellent dispersibility in the resin composition for a non-aqueous secondary battery separator. Further, a separator provided with a protective layer formed from the resin composition for a non-aqueous secondary battery separator has good adhesion and resistance to electrolytic solution. As a result, for example, a non-aqueous secondary battery with the separator enfolded in a spiral form with electrodes has excellent effects that the protective layer hardly cracks and the inorganic filler hardly drops off.

[Monomer (a1)]

The monomer (a1) is a monomer having an acidic functional group. Examples of the acidic functional group include a carboxyl group, a sulfonate group, and a phosphate group. Due to having the acidic functional group, the stability during polymerization improves, and the solution stability of the resin composition for a non-aqueous secondary battery separator improves. In particular, a monomer having a carboxyl group preferably allows the resistance to electrolytic solution of a separator to further improve.

Examples of the monomer containing a carboxyl group include acrylic acid, methacrylic acid, itaconic acid, maleic acid, and 2-methacryloyl propionic acid.

Examples of the monomer containing a sulfonate group include styrene sulfonate, sodium styrene sulfonate, ammonium styrene sulfonate, 2-acrylamido-2-methylpropane sulfonate, sodium 2-acrylamido-2-methyl propanoate, methallylsulfonic acid, sodium methallylsulfonate, ammonium methallylsulfonate, allylsulfonic acid, sodium allylsulfonate, ammonium allylsulfonate, vinylsulfonic acid, sodium vinylsulfonate, ammonium vinylsulfonate, and ammonium allyloxybenzenesulfonate.

Examples of the monomer containing a phosphate group include 2-methacryloyloxyethyl acid phosphate, 2-acryloyloxyethyl acid phosphate, diphenyl-2-acryloyloxyethyl phosphate, diphenyl-2-methacryloyloxyethyl phosphate, dibutyl-2-acryloyloxyethyl phosphate, polypropylene glycol monomethacrylate acid phosphate, and (2-hydroxyethyl) methacrylate acid phosphate.

The content of the monomer (a1) in 100 mass % of the monomer mixture is preferably 0.01 to 5 mass %, more preferably 0.05 to 3 mass %, though not particularly limited.

Thereby, the resistance to electrolytic solution of a separator can be more improved.

[Monomer (a2)]

The monomer (a2) is a monomer having an amide group. Use of the monomer having an amide group allows the polymer (A) to have excellent resistance to electrolytic solution of a separator. Incidentally, a monomer having both an amide group and an acidic functional group is classified as the monomer (a1).

Examples of the monomer (a2) include acrylamide, methacrylamide, diacetone acrylamide, N-methyl acrylamide, N-methyl methacrylamide, N-dimethyl acrylamide, N-ethyl acrylamide, N-diethyl acrylamide, and N-isopropyl acrylamide, N-butyl acrylamide, and hydroxyethyl acrylamide.

In particular, acrylamide or methacrylamide is more preferred from the viewpoint of solution stability of the resin composition for separators and the resistance of separator to electrolytic solution.

The content of the monomer (a2) in 100 mass % of the monomer mixture is preferably 0.01 to 5 mass %, more preferably 0.05 to 3 mass %, though not particularly limited.

Thereby, the solution stability of the resin composition for separators and the resistance of separator to electrolytic solution can be more improved.

[Monomer (a3)]

The monomer (a3) is an alkyl (meth)acrylate monomer. Containing the monomer (a3) allows adhesion to the separator substrate and flexibility of the protective layer to improve. Examples of the alkyl (meth)acrylate monomer include methyl (meth)acrylate, ethyl (meth)acrylate, butyl (meth)acrylate, isobutyl (meth)acrylate, tertiary butyl (meth)acrylate, pentyl (meth)acrylate, hexyl (meth)acrylate, 2-ethylhexyl (meth)acrylate, octyl (meth)acrylate, nonyl (meth)acrylate, decyl (meth)acrylate, undecyl (meth)acrylate, dodecyl (meth)acrylate, tridecyl (meth)acrylate, tetradecyl (meth)acrylate, hexadecyl (meth)acrylate, octadecyl (meth)acrylate, cyclohexyl (meth)acrylate, isobornyl (meth)acrylate, and benzyl (meth)acrylate. In particular, methyl methacrylate, butyl acrylate, and 2-ethylhexyl acrylate are more preferred from the viewpoint of the resistance to electrolytic solution of the separator and adhesion to the separator substrate.

The content of the monomer (a3) in 100 mass % of the monomer mixture is preferably 90 to 99.8 mass %, more preferably 95 to 99 mass %, though not particularly limited. Thereby, copolymerization properties of the polymer (A) are improved, and resistance to electrolytic solution of the separator and adhesion to the separator substrate can also be improved.

[Monomer (a4)]

The monomer (a4) is a monomer having a crosslinkable functional group. The crosslinkable functional group is a functional group that gives a crosslinked structure to the side chain of a polymer, and examples thereof include a glycidyl group, an alkoxysilyl group, and an ethylenically unsaturated group. Examples of the monomer (a4) include a monomer having a glycidyl group, a monomer having an alkoxysilyl group, and a monomer having two or more ethylenically unsaturated bond groups.

No content of the monomer (a4) is preferred, though the monomer (a4) content is not particularly limited. Accordingly, the less the content thereof in 100 mass % of the monomer mixture is, the better. The content is more preferably 5 mass % or less, still more preferably 2 mass % or less, and particularly preferably 0.5 mass % or less. With no content of the monomer (a4), adhesion to the separator substrate can be more improved.

Examples of the monomer having a glycidyl group include glycidyl (meth)acrylate, and 4-hydroxybutyl (meth)acrylate glycidyl ether.

Examples of the monomer having an alkoxysilyl group include γ-methacryloxy propyltrimethoxysilane, γ-methacryloxy propyltriethoxysilane, γ-methacryloxy propyltributoxysilane, γ-methacryloxy propylmethyldimethoxysilane, γ-methacryloxy propylmethyldiethoxysilane, γ-acryloxy propyltrimethoxysilane, γ-acryloxy propyltriethoxysilane, γ-acryloxy propyltributoxysilane, γ-acryloxy propylmethyldimethoxysilane, γ-acryloxy propylmethyldiethoxysilane, vinyltrimethoxysilane, vinyltriethoxysilane, vinyltributoxysilane, vinylmethyldimethoxysilane, and parastyryltrimethoxysilane.

Examples of the monomer having two or more unsaturated bond groups include allyl (meth)acrylate, vinyl (meth)acrylate, ethylene glycol di(meth)acrylate, diethylene glycol di(meth)acrylate, triethylene glycol di(meth)acrylate, polyethylene glycol di(meth)acrylate, 1,4-butanediol di(meth)acrylate, 1,6-hexanediol di(meth)acrylate, 1,9-nonanediol di(meth)acrylate, 1, 10-decanediol di(meth)acrylate, neopentyl glycol di(meth)acrylate, glycerin di(meth)acrylate, dimethylol tricyclodecane di(meth)acrylate, trimethylolpropane tri(meth)acrylate, pentaerythritol tri(meth)acrylate, pentaerythritol tetra(meth)acrylate, divinylbenzene, divinyl adipate, diallyl isophthalate, diallyl phthalate, and diallyl maleate.

[Monomer (a5)]

The monomer (a5) is another monomer polymerizable with a monomer (a1) having an acidic functional group, a monomer (a2) having an amide group, and an alkyl (meth)acrylate monomer (a3). Specifically, a monomer having a hydroxyl group, a monomer having a polyoxyalkylene group, and a vinyl monomer (monomer having one vinyl group) are preferred. Examples of the monomer having a hydroxyl group include 2-hydroxyethyl (meth) acrylate, 2-hydroxypropyl (meth) acrylate, 4-hydroxybutyl (meth)acrylate, glycerol mono(meth)acrylate, and allyl alcohol.

Examples of the monomer having a polyoxyalkylene group include diethylene glycol mono(meth)acrylate, polyethylene glycol mono(meth)acrylate, polyethylene glycol/polypropylene glycol mono(meth)acrylate, methoxydiethylene glycol mono(meth)acrylate, methoxypolyethylene glycol mono(meth)acrylate, phenoxydiethylene glycol mono(meth)acrylate, and phenoxy polyethylene glycol mono(meth)acrylate.

Examples of the vinyl monomer include styrene, α-methylstyrene and vinyl acetate.

### <Condensation Product (B)>

The condensation product (B) is a condensation product of a silane compound (b) represented by the following general formula (1):

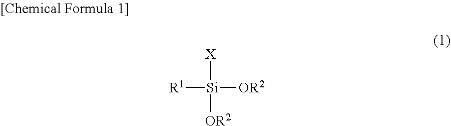

in which R¹ represents an alkyl group having 1 to 18 carbon atoms, a cycloalkyl group having 1 to 18 carbon atoms, or an aryl group having 1 to 18 carbon atoms, R² represent each independently a methyl group or an ethyl group, and X represents a methyl group, a methoxy group, or an ethoxy group.

Examples of the alkyl group having 1 to 18 carbon atoms include a methyl group, an ethyl group, a propyl group, an isopropyl group, a butyl group, an isobutyl group, a tert-butyl group, a hexyl group, an octyl group and 2-ethylhexyl group. Examples of the cycloalkyl group having 1 to 18 carbon atoms include a cyclohexyl group. Examples of the aryl group having 1 to 18 carbon atoms include a phenyl group and a benzoyl group.

Since the silane compound (b) has a hydrocarbon group, which is R¹ in the general formula (1), the condensate (B) thereof has a hydrophobic interaction with the polymer (A), being localized near the polymer (A). Due to the resulting effect, the polymer (A) has good affinity with inorganic filler so as to achieve excellent dispersibility in the resin composition for a non-aqueous secondary battery separator. Further, due to excellent coatability to the separator substrate, the condensate (B) strongly binds to the filler component, so that adhesion and resistance to the electrolytic solution of the separator can be greatly improved by addition of a small amount of the polymer (A). The alkyl group, cycloalkyl group or aryl group represented by R¹ in the general formula (1) in the silane compound (b) may have 1 to 18 carbon atoms, preferably 3 to 12 carbon atoms, and more preferably 4 to 8 carbon atoms. With 1 or more carbon atoms, sufficient hydrophobic interaction with the polymer (A) is achieved, and with 18 or less carbon atoms, the solubility in an aqueous medium is improved.

Examples of the silane compound (b) include methyl trimethoxysilane, methyl triethoxysilane, ethyl trimethoxysilane, ethyl triethoxysilane, propyl trimethoxysilane, propyl triethoxysilane, butyl trimethoxysilane, butyl triethoxysilane, hexyl trimethoxysilane, hexyl triethoxysilane, octyl trimethoxysilane, octyl triethoxysilane, 2-ethylhexyl trimethoxysilane, 2-ethylhexyl triethoxysilane, decyl trimethoxysilane, decyl triethoxysilane, dodecyl trimethoxysilane, dodecyl triethoxysilane, hexadecyl trimethoxysilane, hexadecyl triethoxysilane, octadecyl trimethoxysilane, octadecyl triethoxysilane, dimethyl dimethoxysilane, dimethyl diethoxysilane, methyloctyl dimethoxysilane, methyloctyl diethoxysilane, cyclopentyl trimethoxysilane, cyclopentyl triethoxysilane, cyclohexyl trimethoxysilane, cyclohexyl triethoxysilane, phenyl trimethoxysilane, phenyl triethoxysilane, methylphenyl dimethoxysilane, methylphenyl diethoxysilane, naphthyl trimethoxysilane, and naphthyl triethoxysilane.

In particular, since adhesion to the separator substrate is more improved due to the balance between hydrophilicity and hydrophobicity, hexyl trimethoxysilane is preferred.

The content of the condensation product (B) in 100 mass % of the binder for a non-aqueous secondary battery separator is preferably 0.01 to 20 mass %, more preferably 0.05 to 15 mass %, and still more preferably 0.1 to 10 mass %, though not particularly limited. Thereby, adhesion to the separator substrate can be more improved.

### <Method for Preparing Binder>

The method of polymerizing the monomer mixture in preparation of the polymer (A) is preferably a method of forming a binder dispersion by emulsion polymerization or suspension polymerization in general, though not particularly limited. As a result, the polymer (A) is in a particulate form, so that the condensation product (B) is easily localized near the surface.

The binder is preferably in a particulate form. In that case, the average particle size of the binder is preferably 50 to 500 nm, more preferably 100 to 300 nm. Use of a binder having an average particle size of 50 to 500 nm allows adhesion between the protective layer and the separator substrate (in particular, polyolefin layer) to be more improved. In addition, the solution stability of the resin composition for a non-aqueous secondary battery separator obtained by mixing the binder for a non-aqueous secondary battery separator and the inorganic filler is more improved. The average particle size is average particle size D₅₀ obtained through dynamic light scattering measurement. The measurement can be performed by preparing a diluted solution by diluting the aqueous binder dispersion with water by a factor of 500, and using about 5 mL of the diluted solution for the measurement with NANOTRAC (manufactured by NIKKISO Co., Ltd.).

The condensation product (B) is obtained by dehydration condensation of the silane compound (b) represented by the general formula (1). Accordingly, the polymer (A) and the condensation product (B) may be separately prepared and mixed. Alternatively, for example, the polymer (A) and the condensation product (B) may be synthesized simultaneously by emulsion polymerizing a monomer mixture in an aqueous medium containing a silane compound (b). Thereby, the condensation product (B) of the silane compound (b) is more easily localized near the particle surface of the polymer (A) due to hydrophobic interaction. For this reason, the binder for a non-aqueous secondary battery separator has a drastically improved dispersibility when mixed with an inorganic filler, and can preferably exhibit excellent adhesion to a separator substrate in comparison with conventional binders.

In other words, a step of emulsion polymerizing a monomer mixture in an aqueous medium in which the silane compound (b) represented by the general formula (1) is dissolved, to thereby prepare the polymer (A) and the condensation product (B) is preferred because excellent adhesion to the separator substrate can be exhibited.

The amount of the silane compound (b) added relative to 100 parts by mass of the polymer (A) is preferably 0.01 to 20 parts by mass, more preferably 0.1 to 10 parts by mass. Thereby, adhesion to the separator substrate can preferably be more improved.

Polymerization of such a monomer mixture is preferably performed in the presence of at least one of a surfactant and a protective colloid. The ionic species of the surfactant include anions, cations and nonions, with anions and nonions being preferred. As the surfactant, a reactive surfactant having one or more radically polymerizable unsaturated double bonds in the molecule may also be used.

As the non-reactive surfactant, the anionic surfactant preferably has a main skeleton of sulfosuccinate, alkyl ether, alkylphenyl ether, alkylphenyl ester, (meth)acrylate sulfate, or phosphate. Specific examples of the anionic surfactant include a higher fatty acid salt such as sodium oleate, an alkylaryl sulfonate such as dodecylbenzene sulfonate, an alkyl sulfate such as sodium lauryl sulfate, a polyoxyethylene alkyl ether sulfate such as sodium polyoxyethylene lauryl ether sulfate, an alkyl sulfosuccinate such as sodium monooctyl sulfosuccinate and derivatives thereof, and a polyoxyethylene distyrenated phenyl ether sulfate.

As the non-reactive surfactant, the nonionic surfactant preferably has a main skeleton of alkyl ether, alkylphenyl ether, or alkyl ester. Specific examples of the nonionic surfactant include a polyoxyethylene alkyl ether such as polyoxyethylene lauryl ether and polyoxyethylene stearyl ether; a polyoxyethylene alkylphenyl ether such as polyoxyethylene octylphenyl ether and polyoxyethylene nonylphenyl ether; a sorbitan higher fatty acid ester such as sorbitan monolaurate, sorbitan monostearate and sorbitan trioleate; polyoxyethylene sorbitan higher fatty acid esters such as polyoxyethylene sorbitan monolaurate and polyoxyethylene sorbitan monostearate; a polyoxyethylene higher fatty acid ester such as polyoxyethylene monolaurate and polyoxyethylene monostearate; a glycerin higher fatty acid ester such oleic acid monoglyceride and stearic acid monoglyceride; a polyoxyethylene/polyoxypropylene block copolymers, and a polyoxyethylene distyrenated phenyl ether.

As the surfactant, a reactive surfactant may also be used. Here, the reactive surfactant is a surfactant having one or more radically polymerizable unsaturated double bonds in the molecule. As the reactive surfactant, a compound having a radically polymerizable unsaturated double bond bonded to the above surfactant (preferably anionic surfactant or nonionic surfactant) may be used. Examples of the protective colloid include a water-soluble polymer compound such as polyvinyl alcohol, carboxymethylcellulose, xanthan gum, starch, a self-emulsifying and dispersing polyester resin, and a water-soluble polyester resin. The surfactants and protective colloid are preferably used in an amount of 0.1 to 5 parts by mass relative to 100 parts by mass of the monomer mixture.

The polymerization of the monomer mixture may also be performed in the presence of a radical polymerization initiator (hereinafter referred to as “polymerization initiator”). As the polymerization initiator, a known oil-soluble polymerization initiator or water-soluble polymerization initiator may be used, and use of a water-soluble polymerization initiator is preferred. Examples of the oil-soluble polymerization initiator include an organic oxide such as benzoyl peroxide, tertiary butyl oxybenzoate, tertiary butyl hydroperoxide, tertiary butyl peroxy-2-ethylhexanoate, tertiary butyl peroxy-3,5,5′-trimethylhexanoate, di-tertiary butyl peroxide, cumene hydroperoxide, p-menthane hydroperoxide, and an azobis compound such as 2,2′-azobisisobutyronitrile, 2,2′-azobis-2,4-dimethylvaleronitrile, 2,2′-azobis(4-methoxy-2,4-dimethylvaleronitrile), and 1,1′-azobis-cyclohexane-1-carbonitrile. Examples of the water-soluble polymerization initiator include ammonium persulfate, sodium persulfate, potassium persulfate, hydrogen peroxide, and 2,2′-azobis(2-methylpropionamidine) dihydrochloride. The polymerization initiator is preferably used in an amount of 0.03 to 5 parts by mass relative to 100 parts by mass of the monomer mixture.

In the polymerization, a reducing agent may be used together with the polymerization initiator. Thereby, the polymerization reaction can be accelerated. Examples of the reducing agent include a reducing organic compound such as ascorbic acid, erythorbic acid, tartaric acid, citric acid, glucose, and a metal salt of formaldehyde sulfoxylate etc.; a reducing inorganic compound such as sodium sulfite, sodium bisulfite, sodium metabisulfite (SMBS) and sodium hyposulfite; ferrous chloride, and Rongalite. The reducing agent is preferably used in an amount of 0.01 to 2.5 parts by mass relative to 100 parts by mass of the monomer mixture.

In polymerization of the monomers, a buffer, a chain transfer agent, a basic compound, etc. may be used, if necessary.

Examples of the buffering agent include sodium acetate, sodium citrate, and sodium bicarbonate.

Examples of the chain transfer agent include octyl mercaptan, tertiary dodecyl mercaptan, lauryl mercaptan, stearyl mercaptan, 2-ethylhexyl mercaptoacetate, octyl mercaptoacetate, 2-ethylhexyl mercaptopropionate, and octyl mercaptopropionate.

The basic compound is a compound used for neutralization. Examples of the basic compound include an alkylamine such as trimethylamine, triethylamine and butylamine; an alcohol amine such as 2-dimethylamino ethanol, diethylamino ethanol, diethanolamine, triethanolamine and aminomethyl propanol; and morpholine and ammonia.

As the dispersion medium in polymerization of the polymer (A), water is preferably used, and an aqueous medium in which a water-soluble solvent is dissolved in water may also be used. Examples of the water-soluble solvent include an alcohol, glycol, cellosolve, amino alcohol, amine, ketones, amide carboxylate, amide phosphate, sulfoxide, carboxylate, phosphate, ether, and nitrile.

### (Resin Composition for Non-Aqueous Secondary Battery Separator)

By blending the binder for a non-aqueous secondary battery separator of the present disclosure with an inorganic filler, the resin composition for a non-aqueous secondary battery separator of the present disclosure can be obtained. Then, a protective layer made of the resin composition for a non-aqueous secondary battery separator can be formed on the separator substrate (for example, polyolefin layer). The protective layer allows the risk of explosion of the non-aqueous secondary battery due to short circuiting between both electrodes to be reduced when the non-aqueous secondary battery is overheated. Further, the protective layers can also prevent the separator from being damaged by dendrite particles generated in the electrolytic solution. By blending the binder for a non-aqueous secondary battery separator of the present disclosure with an inorganic filler, resistance to the electrolytic solution and solution stability can be more improved.

At the same time when the resin composition for a non-aqueous secondary battery separators prepared by blending the binder for a non-aqueous secondary battery separator of the present disclosure with an inorganic filler is applied to a separator substrate (e.g., polyolefin layer), the binder functions such that the blended inorganic fillers are point-bonded to each other. Accordingly, the binder is preferably in a particulate form, and dispersibility of the binder is important for adhesion of the resin composition for a non-aqueous secondary battery separator to the separator substrate.

### <Inorganic Filler>

The inorganic filler is preferably composed of an inorganic compound that does not deteriorate in the electrolytic solution of the non-aqueous secondary battery. Specific examples of the inorganic compound include aluminum oxide, zirconium oxide, titanium oxide, silica, and ion conductive glass. The average particle size of the inorganic filler is preferably 0.01 to 10 μm. By using the inorganic filler having the above average particle size, the protective layer can achieve both higher film strength and higher lithium ion conductivity.

The average particle size is average particle size D₅₀ obtained by dynamic light scattering measurement. The measurement can be performed by preparing a dispersion by dispersing with water by a factor of 500 to the inorganic filler weight, and using about 5 mL of the dispersion for the measurement with NANOTRAC (manufactured by NIKKISO Co., Ltd.).

The binder for a non-aqueous secondary battery separator is preferably used in an amount of 0.1 to 10 parts by mass, more preferably used in an amount of 0.1 to 5 parts by mass, relative to 100 parts by mass of the inorganic filler. With use of the binder for a non-aqueous secondary battery separator in an amount of 0.1 to 5 parts by mass relative to 100 parts by mass of the inorganic filler, the conductivity of the lithium ion in the protective layer can be more improved while maintaining the adhesion between inorganic fillers and the excellent adhesion to the separator of the protective layer and flexibility.

The resin composition for a non-aqueous secondary battery separator of the present disclosure preferably combines other optional components such as a leveling agent, a dispersant, a thickener, and an antifoaming agent. Examples of the types of leveling agent include silicon-based, fluorine-based, metal-based, and succinic acid-based ones. Examples of the dispersant include an anionic compound, a nonionic compound, and a polymer compound.

### <Method for Preparing Resin Composition for Non-Aqueous Secondary Battery Separator>

The resin composition for non-aqueous secondary batteries of the present disclosure is obtained by mixing the binder for a non-aqueous secondary battery separator of the present disclosure, an inorganic filler, and optional additives. The resin composition for non-aqueous secondary batteries can be obtained, for example, by dispersing an inorganic filler with a dispersant and then mixing with a binder and optional additives.

The resin composition for a non-aqueous secondary battery separator of the present disclosure may be prepared using a known mixing unit. Specific examples of the mixing unit include a disperser/homomixer, a planetary mixer, a ball mill, a sand mill, an attritor, a pearl mill, a jet mill, and a roll mill.

### (Non-Aqueous Secondary Battery)

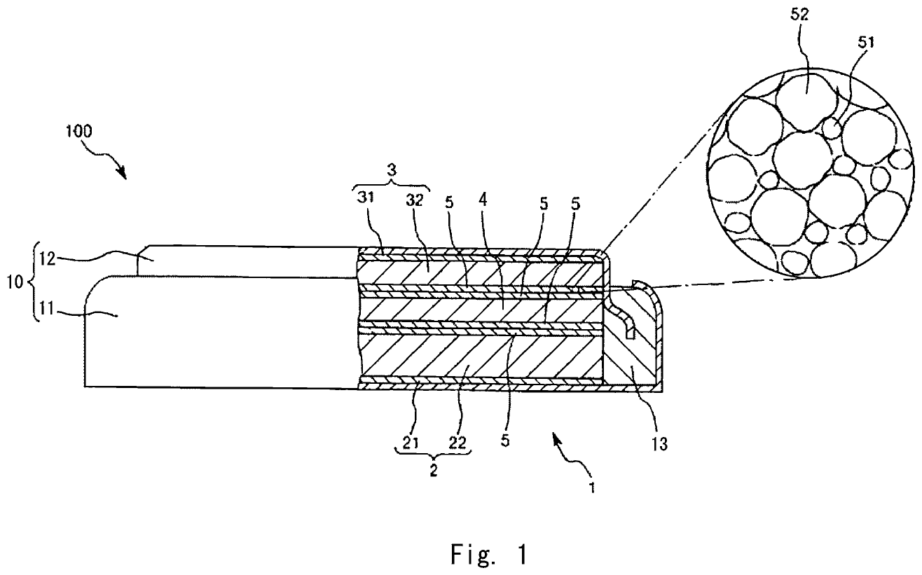

In the following, the non-aqueous secondary battery of the present disclosure will be described using LIB as an example. The LIB has at least a battery body including a positive electrode, a negative electrode and a separator provided between the positive electrode and the negative electrode, and an electrolytic solution impregnated into the battery body. FIG. 1 is a longitudinal sectional view showing the position of LIB in the embodiment. An LIB 100 shown in FIG. 1 includes a battery container 10, a battery body 1 housed in the battery container 10, and an electrolytic solution filled (supplied) in the battery container 10. The battery container 10 houses the battery body 1 in a space defined by a positive electrode case 11, a negative electrode case 12, and a sealing material 13 that liquid-tightly seals the gap between a positive electrode case 11 and a negative electrode case 12. The battery body 1 housed in the battery container 10 is in contact with each of the positive electrode case 11 and the negative electrode case 12.

The battery body 1 includes a positive electrode 2 and a negative electrode 3 (hereinafter collectively referred to as “electrodes” in some cases) and a separator 4 provided between the positive electrode 2 and the negative electrode 3. By housing the battery body 1 in the battery container 10 and filling (supplying) the electrolytic solution into the space in the battery container 10, the electrolytic solution is supported (impregnated) in the battery body 1 (separator 4). The positive electrode 2 and the negative electrode 3 have current collectors 21 and 31, and mixture layers 22 and 32 provided on the separator 4 side of the current collectors 21 and 31, formed from a mixture composition containing an electrode active material as an essential component, respectively.

The positive electrode active material is not particularly limited, and a metal compound such as a metal oxide and a metal sulfide and a conductive polymer, which can be doped or intercalated with lithium ions, may be used. Examples of the metal oxide or metal compound include inorganic compounds such as an oxide of transition metal Fe, Co, Ni and Mn etc., a composite oxide with lithium, and a transition metal sulfide. Specific examples of the metal oxide or metal compound include a powder of transition metal oxide such as MnO, V₂O₅, V₆O₁₃, and TiO₂, a composite oxide powder of lithium and transition metal such as lithium nickel oxide, lithium cobalt oxide and lithium manganese oxide, which have a layered structure, and lithium manganese oxide having a spinel structure, a lithium iron phosphate-based material which is a lithium oxide compound having an olivine structure, and a powder of transition metal sulfide such as TiS₂FeS. These may be used alone or in combination of two or more types.

The negative electrode active material that can be doped or intercalated with lithium ions is not particularly limited. Examples of the negative electrode active material include metal Li, an alloy containing metal Li (e.g., tin alloy, silicon alloy and lead alloy), a metal oxide such as lithium titanium oxide, lithium vanadium oxide and lithium silicon oxide, a conductive polymer such as polyacetylene and poly-p-phenylene, a carbonaceous powder, for example, a carbonaceous powder of an artificial graphite or a natural graphite such as an amorphous carbon material and highly graphitized carbon material of soft carbon and hard carbon, and a carbon material such as carbon black, mesophase carbon black, resin-baked carbon material, vapor-grown carbon fiber and carbon fiber. These may be used alone or in combination of two or more types.

As the current collectors 21 and 31, current collectors applicable to various secondary batteries can be appropriately selected. Examples of the material of the current collectors 21 and 31 include metals such as aluminum, copper, nickel, titanium, and stainless steel, and alloys thereof. In the case of LIB, it is preferable to use a current collector 21 made of aluminum for the positive electrode 2 and a current collector 31 made of copper for the negative electrode 3, respectively. The thickness of the current collectors 21 and 31 is preferably 5 to 50 μm.

A preferred method for forming the mixture layers 22 and 32 is coating. Specific examples of the coating method include die coating, dip coating, roll coating, doctor coating, knife coating, spray coating, gravure coating, screen printing, and electrostatic coating. It is also preferable to dry the solvent during coating. Specifically, a known drying method such as hot air drying, infrared drying, and far infrared drying may be used. The thickness of the mixture layers 22, 32 is preferably 30 to 300 μm.

A separator 4 is provided between the positive electrode 2 and the negative electrode 3 as described above. The separator 4 is a porous sheet or non-woven fabric having fine pores through which ions can pass. Specifically, the separator 4 can be composed of known material such as polyolefin such as polyethylene and polypropylene, cellulose, and aromatic polyamide.

As shown in FIG. 1, a protective layer 5 is formed on both sides of the separator 4. The heat resistance of the separator 4 is improved by the protective layer 5, so that when the non-aqueous secondary battery is overheated, the risk of explosion of the non-aqueous secondary battery due to short circuiting between both electrodes can be reduced. The protective layer 5 is preferably formed on both sides of the separator 4, or may be formed on one side. In the case where the protective layer 5 is formed on one side of the separator 4, the separator 4 is preferably disposed such that the protective layer 5 faces the negative electrode 3 side where dendrite particles tend to preferentially emerge. The thickness of the protective layer 5 is preferably 0.5 to 50 μm, more preferably 1 to 30 μm. With a thickness of the protective layer 5 of 0.5 to 50 μm, the protective layer 5 can have sufficient strength as a film, and a non-aqueous secondary battery having excellent battery performance can be obtained. In particular, the binder for a non-aqueous secondary battery separator of the present disclosure has a high affinity with inorganic filler, so as to achieve excellent adhesion to a separator substrate. As a result, even in the case where the protective layer is a thin film, a separator with a protective layer having improved heat resistance can be obtained.

In the present disclosure, the protective layer 5 has particularly good adhesion to the separator 4 made of polyolefin sheet that is generally difficult to be adhered. Incidentally, the terms sheet, film, and layer have similar meaning. The separator 4 with the protective layer 5 formed thereon constitutes the non-aqueous secondary battery separator (separator with protective layer) of the present disclosure.

As shown enlarged in FIG. 1, the protective layer 5 of the present embodiment is composed of resin composition for a non-aqueous secondary battery separator containing a binder for a non-aqueous secondary battery separator (hereinafter simply referred to as “binder” in some cases) 51 and an inorganic filler 52. The binder 51 point-bonds the inorganic fillers 52 to each other. Thereby, a gap having a sufficient size can be secured between the inorganic fillers 52. Accordingly, the protective layer 5 has excellent ionic conductivity. As a result, LIB 100 having the protective layer 5 has more improved battery characteristics.

The separator 4 is impregnated with (holds) an electrolytic solution. The electrolytic solution is a liquid dissolving an electrolytic solution containing lithium in a non-aqueous solvent. Specific examples of the electrolyte include LiBF₄, LiClO₄, LiPF₆, LiAsF₆, LiSbF₆, LiCF₃SO₃, Li(CF₃SO₂)₂N, LiC₄F₉SO₃, Li(CF₃SO₂)₃C, LiI, LiBr, LiCl, LiAlCl, LiHF₂, LiSCN, and LiBPh₄.

Examples of the non-aqueous solvent include a carbonate such as ethylene carbonate, propylene carbonate, butylene carbonate, dimethyl carbonate, ethyl methyl carbonate, and diethyl carbonate; a lactone such as T-butyl lactone, γ-valerolactone, and γ-octanoic lactone; a glyme such as tetrahydrofuran, 2-methyltetrahydrofuran, 1,3-dioxolane, 4-methyl-1,3-dioxolane, 1,2-methoxyethane, 1,2-ethoxyethane and 1,2-dibutoxyethane; an ester such as methyl formate, methyl acetate and methyl propionate; a sulfoxide such as dimethyl sulfoxide and sulfolane; and a nitrile such as acetonitrile. These may be used alone or in combination of two or more.

It is also preferable to use the electrolytic solution as a gelled polymer electrolyte held in a polymer matrix. Specific examples of the material for the polymer matrix include an acrylic resin having a polyalkylene oxide segment, a polyphosphazene resin having a polyalkylene oxide segment, and a polysiloxane resin having a polyalkylene oxide segment.

In the present embodiment, a button-type LIB has been described as a non-aqueous secondary battery. However, the non-aqueous secondary battery of the present disclosure is not limited thereto, and may be a cylindrical-type, square-type, coin-type, bag-type, a sheet-type, or the like. For example, in the case of a non-aqueous secondary battery of cylindrical or rectangular type, the battery body 1 may be wound into a cylindrical shape or rectangular tube shape and housed in the battery container 10. As described above, the inorganic filler 52 has good affinity with the binder 51 and is uniformly dispersed in the resin composition for a non-aqueous secondary battery separator. Accordingly, even with the battery body 1 rolled into a cylindrical shape or square tube shape, the protective layer 5 is hardly cracked, and the inorganic filler 52 hardly drops off from the protective layer 5.

A non-aqueous secondary battery with use of the members is excellent in safety and battery characteristics. The non-aqueous secondary battery of the present disclosure may be for industrial use, vehicle use, or mobile use.

The binder for a non-aqueous secondary battery separator, the resin composition for a non-aqueous secondary battery separator, the non-aqueous secondary battery separator, and the non-aqueous secondary battery of the present disclosure have been described based on preferred embodiments. However, the present disclosure is not limited thereto. Each configuration may be replaced with any one that can exhibit a similar function, or an optional configuration may be added thereto.

For example, the protective layer 5 may be provided on both sides of the separator 4 as shown in FIG. 1, or may be provided on only one side. Also, the protective layer 5 may be provided in direct contact with the separator 4, or one or more layers may be provided between the protective layer 5 and the separator 4 for any purpose (e.g., improvement of adhesion, improvement of smoothness, etc.).

### Embodiment 2

Hereinafter, embodiments of a binder, an aqueous dispersion, a resin composition, a separator, and an electricity storage device that suitably achieve the second object of the present disclosure will be described. The present disclosure is not limited thereto. Descriptions similar to those in the embodiment 1 may be omitted to avoid repetition.

In the present specification, a numerical range specified using “to” includes the numerical values at front and rear of “to” as the lower and upper limits of the range, respectively.

The monomer means a monomer having an ethylenically unsaturated double bond, and a monomer (c1) having an acidic group, a monomer (c2) having an amide group, and a monomer (c3) other than the monomer (c1) having an acidic functional group or the monomer (c2) having an amide group may be abbreviated as monomer (c1), monomer (c2) and monomer (c3), respectively. An alkoxy monosilane compound (d1) having no ethylenically unsaturated group but having an alkyl group having 3 to 12 carbon atoms and another alkoxy monosilane compound (d2) other than (d1) may be abbreviated as silane compounds (d1) and silane compound (d2), respectively. Further, unless otherwise specified, the term “(meth)acrylic” means “acrylic or methacrylic”, and “meth(eth)oxy” means “methoxy or ethoxy”.

### (Binder)

The binder of the present disclosure is used to form a protective layer of a separator provided between electrodes of an electricity storage device. The binder contains the polymer (C) of the ethylenically unsaturated monomer (c), and a silane compound, and the silane compound has no ethylenically unsaturated group but has an alkyl group having 3 to 12 carbon atoms. Since the silane compound has an alkyl group having 3 to 12 carbon atoms, the compatibility between the polymer (C) and the silane compound is improved. It is therefore presumed that extreme localization of the silane compound in the polymer is reduced, resulting in improved stability. Further, since the silane compound has no ethylenically unsaturated group, chemical bonding with the polymer (C) or polymerization of the ethylenically unsaturated groups of the silane compound hardly occurs. Accordingly, there exists no risk of insufficient binding effect or adverse effect on the characteristics of the separator or battery due to generation of aggregates derived from the silane compound. It is therefore presumed that the binding property to the separator substrate and the binding property to the inorganic filler component in the case where the inorganic filler is contained are drastically improved, and the characteristics of the separator and the electricity storage device are improved. Although the form of the binder is not particularly limited, a form of an aqueous dispersion in an aqueous medium is more preferred.

The binder may be prepared by any method, including a method of mixing the polymer (C) and a silane compound, or a method of previously mixing the ethylenically unsaturated monomer (c) and a silane compound and then polymerizing the mixture. From the viewpoint of easily obtaining a more stable binder, a method of previously mixing the ethylenically unsaturated monomer (c) and the precursor of a silane compound, and then emulsion polymerizing the emulsion of the mixture is preferred.

The binder preferably has an acid value. In the case where the binder has an acid value, the acid value of the binder is preferably in the range of 2 to 40 mg KOH/g. With an acid value in the range, the resin composition is more stable, and the binding property of the binder to the separator substrate and the binding property to the inorganic filler when contained are good after long-term storage. Accordingly, it is presumed that the separator and the electricity storage device can exhibit excellent physical properties.

The glass transition temperature (Tg) of the binder is preferably in the range of −60 to 40° C. With a Tg in the range, the mobility of the binder component at the time of binding is sufficiently ensured, so that the binding to the separator substrate and the binding to the inorganic filler when contained are enhanced, with the strength being also ensured. It is presumed that the characteristics of the separator and the electricity storage device are enhanced thereby. Tg can be determined through measurement using a differential scanning calorimeter (DSC, manufactured by TA Instruments, etc.).

### <Polymer (C)>

In the present specification, the polymer (C) refers to a polymer of ethylenically unsaturated monomer (c), and is used as a main component of the binder for bonding to a separator substrate. In the case where an inorganic filler is contained, the polymer (C) is used to bind the separator substrate to the inorganic filler, and to bind the inorganic fillers to each other.

The ethylenically unsaturated monomer (c) preferably contains at least one selected from the group consisting of a monomer (c1) having an acidic group and a monomer (c2) having an amide group. By containing the monomer (c1) and/or the monomer (c2), the resin composition has improved stability over time, and it is presumed that excellent physical properties of the separator and the electricity storage device can be exhibited even after the passage of time.

[Monomer (c1)]

The monomer (c1) is a monomer having an acidic group. Examples of the monomer (c1) include a carboxy group-containing ethylenically unsaturated monomer such as maleic acid (anhydride), fumaric acid, itaconic acid, citraconic acid, or an alkyl or alkenyl monoester thereof, succinic acid β-(meth)acryloxyethyl monoester, (meth)acrylic acid, crotonic acid and cinnamic acid; and a sulfo group-containing ethylenically unsaturated monomer such as sodium 2-acrylamide-2-methylpropanesulfonate, methallyl sulfonic acid, sodium methallyl sulfonate, sodium styrene sulfonate, allylsulfonic acid, sodium allylsulfonate, ammonium allylsulfonate, and vinylsulfonic acid. These may be used alone, or two or more thereof may be used in combination at any ratio.

Among the above, the monomer (c1) preferably contains a carboxy group-containing ethylenically unsaturated monomer, more preferably contains a monomer having a carboxy group and a (meth)acryloyl group, and still more preferably contains (meth)acrylic acid.

[Monomer (c2)]

The monomer (c2) is a monomer having an amide group (—CON=group). Examples of the monomer (c2) include (meth)acrylamide, N-methoxymethyl-(meth)acrylamide, N-ethoxymethyl-(meth)acrylamide, N-propoxymethyl-(meth)acrylamide, N-butoxymethyl-(meth)acrylamide, N-pentyloxymethyl-(meth)acrylamide, N,N-di(methoxymethyl)acrylamide, N-ethoxymethyl-N-methoxymethyl methacrylamide, N,N-di(ethoxymethyl)acrylamide, N-ethoxymethyl-N-propoxymethyl methacrylamide, N,N-di(propoxymethyl)acrylamide, N-butoxymethyl-N-(propoxymethyl)methacrylamide, N,N-di(butoxymethyl)acrylamide, N-butoxymethyl-N-(methoxymethyl)methacrylamide, N,N-di(pentyloxymethyl)acrylamide, N-methoxymethyl-N-(pentyloxymethyl)methacrylamide, N,N-dimethylaminopropyl acrylamide, N,N-diethylaminopropyl acrylamide, N,N-dimethylacrylamide, N,N-diethyl acrylamide, diacetone (meth)acrylamide, N-vinylpyrrolidone, N-vinyl acetamide, methylene bisacrylamide, and N-hydroxymethyl acrylamide. These may be used alone, or two or more thereof may be used in combination at any ratio. Among the above, the monomer (c2) preferably includes diacetone (meth)acrylamide or (meth)acrylamide, and more preferably includes (meth)acrylamide, from the viewpoint of better binding property and more improved heat resistance, adhesion, and abrasion resistance of the separator.

The total content of the monomer (c1) and the monomer (c2) based on the total amount of the monomer (c) is in the range of preferably 0.5 to 10 mass %, more preferably 0.8 to 7 mass %. With a content in the range, it is presumed that the stability over time of the resin composition is more improved, and excellent physical properties of the separator and the electricity storage device can be exhibited even after the passage of time.

[Monomer (c3)]

The monomer (c) may contain an ethylenically unsaturated monomer (c3) other than the monomer (c1) and the monomer (c2). Examples of the monomer (c3) include an aromatic ethylenically unsaturated monomer such as vinylnaphthalene, benzyl (meth)acrylate, phenoxyethyl (meth)acrylate, phenoxydiethylene glycol (meth)acrylate, phenoxytetraethylene glycol (meth)acrylate, phenoxyhexaethylene glycol (meth)acrylate, and phenyl (meth)acrylate; a linear or branched alkyl group-containing ethylenically unsaturated monomer such as methyl (meth)acrylate, ethyl (meth)acrylate, butyl (meth)acrylate, t-butyl (meth)acrylate, pentyl (meth)acrylate, heptyl (meth)acrylate, hexyl (meth)acrylate, 2-ethylhexyl (meth)acrylate, octyl (meth)acrylate, nonyl (meth)acrylate, decyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, stearyl (meth)acrylate, isostearyl (meth)acrylate, and behenyl (meth)acrylate; a cycloalkyl group-containing ethylenically unsaturated monomer such as cyclohexyl (meth)acrylate and isobornyl (meth)acrylate; a fluorinated alkyl group-containing ethylenically unsaturated monomer such as trifluoroethyl (meth)acrylate; a nitrile group-containing ethylenically unsaturated monomer such as (meth)acrylonitrile; a hydroxyl group-containing ethylenically unsaturated monomer such as 2-hydroxyethyl (meth)acrylate, 2-hydroxypropyl (meth)acrylate, 4-hydroxybutyl (meth)acrylate, glycerol mono(meth)acrylate, 4-hydroxyvinylbenzene, 1-ethynyl-1-cyclohexanol, and allyl alcohol; a polyoxyethylene group-containing ethylenically unsaturated monomer such as methoxypolyethylene glycol (meth)acrylate and polyethylene glycol (meth)acrylate; an amino group-containing ethylenically unsaturated monomer such as N,N-dimethylaminoethyl (meth)acrylate, N,N-diethylaminoethyl (meth)acrylate, N-methyl-N-ethyl aminoethyl (meth)acrylate, N,N-dimethylamino styrene, and N,N-diethylamino styrene; an epoxy group-containing ethylenically unsaturated monomer such as glycidyl (meth)acrylate and 3,4-epoxycyclohexyl (meth)acrylate; and a ketone group-containing ethylenic unsaturated monomer such as acetoacetoxy (meth)acrylate, though not particularly limited thereto.

It is preferable that the monomer (c3) include any of an aromatic ethylenically unsaturated monomer, an alkyl group-containing ethylenically unsaturated monomer, a cycloalkyl group-containing ethylenically unsaturated monomer, and a hydroxyl group-containing ethylenically unsaturated monomer, in particular.

Further, in the case where the monomer (c3) is included, it is preferable that the monomer has an octanol/water partition coefficient (abbreviated as log Kow) of 1 to 5 at 25° C. Based on the total amount of the ethylenically unsaturated monomer (c), the content of the monomer having a log Kow of 1 to 5 is preferably in the range of 60 mass % or more and less than 100 mass %. With a content in the range, the compatibility between the polymer (C) and the silane compound is more improved. For example, in the case where the binder is in an aqueous dispersion form, the silane compound is separated from the polymer (C), so that extreme localization in the center of the dispersion can be suppressed. Accordingly, it is presumed that the stability of the resin composition over time is good, and the excellent characteristics of the separator and electricity storage device can be exhibited even after the passage of time. It is more preferable that the monomer (c3) includes a monomer having a log Kow of 1.13 to 4.01, for further improvement in the performance of the electricity storage device.

Examples of ethylenically unsaturated monomers having a log Kow of 1 to 5 include styrene (log Kow: 3.06), α-methylstyrene (log Kow: 3.06), benzyl acrylate (log Kow: 2.32), benzyl methacrylate (log Kow: 2.91), phenoxyethyl acrylate (log Kow 2.44), methyl methacrylate (log Kow: 1.13), ethyl acrylate (log Kow: 1.16), ethyl methacrylate (log Kow: 1.78), propyl acrylate (log Kow: 1.67), propyl methacrylate (log Kow: 2.28), butyl acrylate (log Kow: 2.23), butyl methacrylate (log Kow: 2.84), t-butyl methacrylate (log Kow: 2.67), hexyl acrylate (log Kow: 3.11), hexyl methacrylate (log Kow: 3.50), cyclohexyl methacrylate (log Kow: 3.06), 2-ethylhexyl acrylate (log Kow: 4.01), octyl acrylate (log Kow: 4.20), and isononyl acrylate (log Kow: 4.66), though not particularly limited thereto.

### <Method for Preparing Polymer (C)>

The method of polymerizing the ethylenically unsaturated monomer (c) to prepare the polymer (C) is not particularly limited and may be solution polymerization, suspension polymerization, bulk polymerization or emulsion polymerization. From the viewpoint of easily obtaining a polymer having a high molecular weight, a low viscosity, and a high solid content in an aqueous medium, emulsion polymerization is preferred.

The polymer (C) may be a polymer dissolved in a solvent, or a polymer in a particulate form dispersed in an aqueous medium. From the viewpoint of more excellence in stability over time and improvement in characteristics of the electricity storage device, a polymer in a particulate form is more preferred.

As the radical polymerization initiator used for the polymerization reaction of the ethylenically unsaturated monomer mixture, known oil-soluble polymerization initiators or water-soluble polymerization initiators may be used. The radical polymerization initiator is preferably used in an amount of 0.1 to 4 parts by mass, more preferably 0.2 to 2 parts by mass, based on 100 parts by mass of the ethylenically unsaturated monomer mixture.

The oil-soluble polymerization initiator is not particularly limited, and examples thereof include an organic peroxide such as benzoyl peroxide, t-butyl peroxy benzoate, t-butyl hydroperoxide, t-butyl peroxy (2-ethyl hexanoate), t-butyl peroxy-3,5,5-trimethyl hexanoate, and di-t-butyl peroxide; an azobis compounds such as 2,2′-azobis isobutyronitrile, 2,2′-azobis-2,4-dimethyl valeronitrile, 2,2′-azobis(4-methoxy-2,4-dimethyl valeronitrile), and 1,1′-azobis-cyclohexane-1-carbonitrile.

In emulsion polymerization, it is preferable to use a water-soluble polymerization initiator. As the water-soluble polymerization initiator, a conventionally known one such as ammonium persulfate (APS), potassium persulfate (KPS), hydrogen peroxide, 2,2′-azobis(2-methylpropion amidine)dihydrochloride may be preferably used.

In obtaining the polymer (C) by emulsion polymerization, it is preferable to perform the polymerization in the presence of at least one of a surfactant and a protective colloid, from the viewpoint of the stability of the aqueous dispersion. Examples of the surfactant include an anionic surfactant, a cationic surfactant and a nonionic surfactant, and an anionic surfactant and/or a nonionic surfactant are preferred.

As the non-reactive surfactant, an anionic surfactant having a main skeleton of sulfosuccinate, alkyl ether, alkylphenyl ether, alkylphenyl ester, (meth)acrylate sulfate, or phosphate is preferred. Specific examples of the anionic surfactant include a higher fatty acid salt such as sodium oleate, an alkylaryl sulfonate such as dodecylbenzene sulfonate and an alkyl sulfate salt such as sodium lauryl sulfate, a polyoxyethylene alkyl ether sulfate such as sodium polyoxyethylene lauryl ether sulfate, an alkyl sulfosuccinate such as sodium monooctyl sulfosuccinate and a derivative thereof, and a polyoxyethylene distyrenated phenyl ether oxalate.

As the non-reactive surfactant, the nonionic surfactant has a main skeleton of preferably alkyl ether, alkylphenyl ether, or alkyl ester. Specific examples of the nonionic surfactant include a polyoxyethylene alkyl ether such as polyoxyethylene lauryl ether and polyoxyethylene stearyl ether; a polyoxyethylene alkylphenyl ether such as polyoxyethylene octylphenyl ether and polyoxyethylene nonylphenyl ether; a sorbitan higher fatty acid ester such as sorbitan monolaurate, sorbitan monostearate, and sorbitan trioleate; a polyoxyethylene sorbitan higher fatty acid ester such as polyoxyethylene sorbitan monolaurate and polyoxyethylene sorbitan monostearate; a polyoxyethylene higher fatty acid ester such as polyoxyethylene monolaurate and polyoxyethylene monostearate; a glycerin higher fatty acid ester such as oleic acid monoglyceride and stearic acid monoglyceride; a polyoxyethylene/polyoxypropylene block copolymer, and a polyoxyethylene distyrenated phenyl ether.

The surfactant for use may also be a reactive surfactant. Here, the reactive surfactant refers to a surfactant having one or more radically polymerizable unsaturated double bonds in the molecule. Examples of the reactive surfactant include a compound in which radically polymerizable unsaturated double bonds are bonded to the non-reactive surfactant (preferably an anionic surfactant or nonionic surfactant).

Examples of the protective colloid include a water-soluble polymer compound such as polyvinyl alcohol, carboxymethyl cellulose, xanthan gum, starch, a self-emulsifying and dispersing polyester resin, and a water-soluble polyester resin. The surfactants and protective colloids are preferably used in an amount of 0.1 to 5 parts by mass relative to 100 parts by mass of the ethylenically unsaturated monomer (c) in total.

In emulsion polymerization, a reducing agent may be used together with the polymerization initiator. By using a reducing agent together, the emulsion polymerization rate can be accelerated and emulsion polymerization at low temperatures can be facilitated. Examples of the reducing agent include a reducing organic compound such as ascorbic acid, erythorbic acid, tartaric acid, citric acid, glucose, and a metal salt such as formaldehyde sulfoxylate; a reducing inorganic compound such as sodium thiosulfate, sodium sulfite, sodium bisulfite, and sodium metabisulfite; ferrous chloride, Rongalite, and thiourea dioxide. These reducing agents are preferably used in an amount of 0.05 to 5 parts by mass relative to 100 parts by mass of the ethylenically unsaturated monomer mixture (c) in total.

The polymerization temperature may be equal to or more than the decomposition temperature of the polymerization initiator. For example, a peroxide-based polymerization initiator has a polymerization temperature of usually about 80° C. The polymerization time is not particularly limited and usually 2 to 24 hours. The ethylenically unsaturated monomer mixture may be polymerized by photochemical reaction or radiation exposure without use of the polymerization initiator described above.

In polymerization of the monomer (c), a buffering agent or a chain transfer agent may be used if necessary. Examples of the buffering agent include sodium acetate, sodium citrate, and sodium bicarbonate. Examples of the chain transfer agent include hexyl mercaptan, heptyl mercaptan, t-hexyl mercaptan, t-heptyl mercaptan, octyl mercaptan, t-octyl mercaptan, nonyl mercaptan, t-nonyl mercaptan, decyl mercaptan, t-decyl mercaptan, undecyl mercaptan, t-undecyl mercaptan, dodecyl mercaptan, t-dodecyl mercaptan, tridecyl mercaptan, t-tridecyl mercaptan, tetradecyl mercaptan, t-tetradecyl mercaptan, heptadecyl mercaptan, t-heptadecyl mercaptan, t-hexadecyl mercaptan, hexadecyl mercaptan, octadecyl mercaptan, t-heptadecyl mercaptan, t-octadecyl mercaptan, mercaptan 2-ethylhexyl mercaptoacetate, octyl mercaptoacetate, methoxy butyl mercaptopropionate, 2-ethylhexyl mercaptopropionate, octyl mercaptopropionate, and stearyl mercaptopropionate. The buffering agent is used preferably in the range of 0 to 1 part by mass, more preferably in the range of 0.05 to 0.5 parts by mass, relative to 100 parts by mass of the ethylenically unsaturated monomer (c) in total. Also, the chain transfer agent is used preferably in the range of 0.4 to 3 parts by mass, more preferably in the range of 0.6 to 2 parts by mass, relative to 100 parts by mass of the ethylenically unsaturated monomer (c) in total.

A basic compound may be used as a neutralizing agent during or after the polymerization of the ethylenically unsaturated monomer (c) in order to increase the stability of the polymer (C). Examples of the basic compound include an organic base such as dimethylaminoethanol, diethanolamine and triethanolamine; and an inorganic base such as ammonia water and an alkali metal hydroxide such as sodium hydroxide, lithium hydroxide and potassium hydroxide. The basic compound may be added during the polymerization reaction or after completion of the polymerization reaction. In the case where the polymer (C) has an acidic group, the basic compound is used preferably in the range of 0.75 to 1.2 mol based on 1 mol of the acidic group in the polymer (C).

### <Silane Compound>

The silane compound used in the present disclosure includes a silane compound having no ethylenically unsaturated group but having an alkyl group having 3 to 12 carbon atoms. The silane compound is used to more improve the binding property to the separator substrate and to the inorganic filler component and the like when contained. It is preferable that the silane compound contain a condensate (D) of an alkoxy monosilane compound (d) having no ethylenically unsaturated group but having an alkyl group having 3 to 12 carbon atoms. The alkoxy monosilane compound (d) reacts with water to easily produce a hydroxy monosilane compound and an alcohol, and the hydroxy monosilane compounds are condensed to each other to produce a condensate (D).

Examples of the alkoxy monosilane compound (d) having no ethylenically unsaturated group but having an alkyl group having 3 to 12 carbon atoms include propyl trimeth(eth)oxysilane, butyl trimeth(eth)oxysilane, hexyl trimeth(eth)oxysilane, octyl trimeth(eth)oxysilane, decyl trimeth(eth)oxysilane, and dodecyl trimeth(eth)oxysilane.

From the viewpoint of adhesion to the separator substrate, resistance to electrolytic solution, heat resistance, characteristics of the electricity storage device, etc., the number of carbon atoms in the alkyl group in the silane compound (d) has a lower limit of 3, preferably 6, and an upper limit of 12, preferably 10. Specifically, hexyl trimeth(eth)oxysilane, octyl trimeth(eth)oxysilane, and decyl trimeth(eth)oxysilane are preferred. The alkoxy monosilane compound (d) may be used alone or in combination of two or more.

Further, the complete hydrolysate of the alkoxy monosilane compound (d) has an octanol/water partition coefficient (log Kow) at 25° C. of preferably −1.5 to 6, more preferably log Kow in the range of −1.32 to 5.78. With a partition coefficient (log Kow) in the range, the polymer (C) and the silane compound are less likely to separate, and the compatibility with the polymer (C) is improved. For example, in the case where the binder is in an aqueous dispersion form, the silane compound is separated from the polymer (C), and extreme localization in the center of the dispersion can be suppressed. Accordingly, it is presumed that the resin composition is more stable over time, and the excellent characteristics of the separator and electricity storage device can be maintained after the passage of time.

The octanol/water partition coefficient (log Kow) is represented by the following (Formula 1), and is used as an index indicating whether a certain compound X is likely to be partitioned into an aqueous phase or an oil phase (octanol). The log Kow of each compound may be calculated from an experiment such as the flask shaking method and high performance liquid chromatography (HPLC) method, or may be calculated from simulation from chemical structures such as the YMB method of the Hansen solubility parameter software HSPiP (physical property estimation function).

$$( Formula 1 )$$

$$log Kow = log ( Concentration of compound X in \text{} octanol phase / Concentration of compound X in aqueous phase )$$

Examples of the alkoxy monosilane compound (d) having an octanol/water partition coefficient (log Kow) at 25° C. of its completely hydrolysate of −1.5 to 6.0 include propyl trimeth(eth)oxysilane (log Kow of complete hydrolysate: −1.32), butyl trimeth(eth)oxysilane (log Kow of complete hydrolysate: −0.75), hexyl trimeth(eth)oxysilane (log Kow of complete hydrolysate: 2.99), octyl trimeth(eth)oxysilane (log Kow of complete hydrolysate: 3.96), decyl trimeth(eth)oxysilane (log Kow of complete hydrolysate: 4.78), and dodecyl trimeth(eth)oxysilane (log Kow of complete hydrolysate: 5.78).

The content of the silane compound is preferably 0.2 to 20 mass %, more preferably 0.4 to 10 mass %, based on the polymer (C). With a content is 0.2 mass % or more, the effect of the silane compound can be sufficiently exhibited, so that the adhesion, resistance to electrolytic solution and heat resistance of the separator, and the cycle characteristics of the electricity storage device are more improved. With a content is 20 mass % or less, the resistance to electrolytic solution of the separator and the cycle characteristics of the electricity storage device are more excellent.

It is preferable that the silane compound is composed only of a silane compound having no ethylenically unsaturated group but having an alkyl group having 3 to 12 carbon atoms. The silane compound, however, may include in combination a silane compound other than the silane compound having no ethylenically unsaturated group but having an alkyl group having 3 to 12 carbon atoms, in the range without negative effect on various physical properties.

### (Aqueous Dispersion of Binder)

The aqueous dispersion of the binder of the present disclosure refers to one containing the binder of the present disclosure and an aqueous medium.

### <Aqueous Medium>

In the present specification, the aqueous medium refers to an aqueous dispersion medium or an aqueous solvent. Examples of the aqueous medium include water, and a medium containing a water-soluble solvent is also regarded as aqueous medium. Examples of the water-soluble solvent include alcohols, glycols, cellosolves, amino alcohols, amines, ketones, carboxylic acid amides, phosphoric acid amides, sulfoxides, carboxylic acid esters, and phosphoric acid esters, ethers, and nitriles.

### <Average Particle Size of Binder>

In the case where the binder is in an aqueous dispersion form, the binder preferably has an average particle size of 50 to 500 nm, more preferably 80 to 300 nm, in measurement by dynamic light scattering. With an average particle size of the binder in the range, the binder is less likely to adversely affect the ionic conductivity, and the binding property to the separator substrate and the binding property to the inorganic filler when contained are also excellent. It is therefore presumed that the characteristics of the separator and the electricity storage device are improved.

The average particle size may be measured, for example, by a dynamic light scattering measurement method (Nanotrac Wave II EX150, manufactured by Microtrac Bel Co., Ltd.). The peak of the volume particle size distribution data (histogram) obtained thereby is taken as the average particle size.

### (Resin Composition)

The resin composition of the present disclosure is used to form a protective layer on a separator of an electricity storage device, and contains the binder and an inorganic filler. The resin composition of the present disclosure is very stable over time, having good coatability and excellent adhesion to a separator substrate even after long-term storage at high temperatures.

### <Inorganic Filler>

The inorganic filler for use in the present disclosure can form a porous structure with excellent heat resistance on the substrate. The inorganic filler is preferably a particle insoluble in a solvent or a non-aqueous electrolytic solution or the like used in an electricity storage device, capable of maintaining the shape. Further, the inorganic filler is preferably a fine particle which is electrochemically stable and stable even under operating environment of an electricity storage device.

The inorganic filler is preferably non-conductive inorganic particles. Examples of the inorganic filler include particles of inorganic oxide such as aluminum oxide (alumina), aluminum oxide hydrates (boehmite (AlOOH) and gibbsite (Al(OH)₃), silicon oxide, magnesium oxide (magnesia), calcium oxide, titanium oxide (titania), barium titanate (BaTiO₃), ZrO, and alumina-silica composite oxide; particles of inorganic nitride such as aluminum nitride and boron nitride; particles of covalent crystal such as silicon and diamond; particles of poorly soluble ionic crystal such as barium sulfate, calcium fluoride and barium fluoride; and clay particles such as talc and montmorillonite. These particles may be subjected to element substitution, surface treatment, solid solution treatment, etc., if necessary. Among the inorganic fine particles, it is more preferable to use particles of barium sulfate or alumina from the viewpoint of excellent dispersion stability, heat resistance of the separator, and various resistance of the coating film.

The average particle size of the inorganic filler is preferably in the range of 0.2 to 5 μm, more preferably in the range of 0.3 to 2 μm. With an average particle size in the range, the heat resistance and the like of the separator are excellent, and the ionic conductivity is less likely to deteriorate, so that an electricity storage device with better electric characteristics can be obtained. The average particle size of the inorganic filler may be measured as the average equivalent circle diameter of individual particles as follows. An image of the particulate powder observed by a scanning electron microscope (SEM) JSM-7800F (manufactured by JEOL Ltd.) at a magnification of 15000 is introduced into an image processing software Winroof (manufactured by Mitani Corporation) to extract the spherical structure.

In the resin composition, the solid content of the binder is preferably 0.5 to 4 parts by mass, more preferably 1.0 to 3 parts by mass, relative to 100 parts by mass of the inorganic filler. With a content in the range, the storage stability of the resin composition is good, and the characteristics of the separator and the electricity storage device are also more excellent.

### <Optional Component>

The resin composition of the present disclosure may contain additives such as an antifoaming agent, a leveling agent, a preservative, a solvent, a cross-linking agent, a dispersant and a binder as optional components. In the case where the optional components remain in the protective layer, it is more preferable that no negative effect be given to various physical properties of the separator and the electricity storage device.

### (Separator)

The separator of the present disclosure refers to a separator substrate provided with a protective layer formed from the binder, aqueous dispersion of the binder, or resin composition of the present disclosure. Usually, the protective layer is provided on one side or both sides of the separator substrate. In the case where the separator substrate is porous, the separator substrate may be impregnated with the resin composition or the like, so that the protective layer may be formed in (inside) the separator substrate. The protective layer may be usually formed by applying a resin composition or the like onto the separator substrate and then drying the applied resin composition.

### <Separator Substrate>

Examples of the substrate used for a separator include a known substrate such as organic separator substrate, though not particularly limited. An organic separator substrate is an organic material having a porous structure. Examples of the organic separator substrate include a porous film or nonwoven fabric containing a polyolefin resin such as polyethylene and polypropylene or an aromatic polyamide resin. Among these substrates, a polyethylene substrate is preferably used from the viewpoint of excellence in safety and electric characteristics.

The thickness of the separator substrate is not particularly limited, preferably in the range of 5 to 30 μm, and more preferably in the range of 5 to 10 μm. With a thickness of the substrate in the range, the safety of a battery is sufficiently ensured, while good ionic conductivity is maintained, so that the electricity storage device can exhibit more excellent electric characteristics.

### <Protective Layer>

The thickness of the protective layer is not particularly limited, preferably in the range of 1 to 5 μm and more preferably in the range of 1.5 to 3.5 μm. With a thickness of the protective layer in the range, the various physical properties of the separator are excellent, and the electric properties of the electricity storage device are also preferable.

### <Method for Preparing Separator>

Examples of the method of forming a protective layer on a substrate include a method of applying the resin composition or the like on a substrate and then drying the applied resin composition, or a method of applying the resin composition or the like on a release substrate, drying the applied resin composition to make a protective layer, and then transferring the layer to the surface of the substrate. From the viewpoint of forming a uniform protective layer with high accuracy, a method of applying a resin composition or the like onto a substrate and then drying the applied resin composition is preferred. The method of applying the resin composition or the like onto a substrate is not particularly limited, and examples thereof include a method such as a doctor blade method, a reverse roll method, a direct roll method, a gravure method, an extrusion method, brush coating, and bar drawing.

### (Electricity Storage Device)

The electricity storage device of the present disclosure refers to an electricity storage device having a separator substrate provided with at least one of the protective layer between a pair of electrodes. Examples of the electricity storage device include a battery, a capacitor, and a condenser, and the electricity storage device of the present disclosure is preferably used as a secondary battery, which is one aspect of batteries, particularly as a non-aqueous secondary battery. In the case where the electricity storage device of the present disclosure is used as a non-aqueous secondary battery, in one aspect of the non-aqueous secondary battery, electrodes including a positive electrode and a negative electrode, the separator and the electrolytic solution may be provided, and if necessary, a binder for electrodes and a current collector may be further provided. Conventionally known materials may be used for the positive electrode, the negative electrode, the electrolytic solution, the binder for electrodes, and the current collector. The electricity storage device of the present disclosure exhibits excellent electric characteristics (for example, cycle characteristics) due to the separator provided with the protective layer having excellent performance.

### EXAMPLES

### Example A

The present disclosure will be described in more detail with reference to Example A in the following, though the present disclosure is not limited thereto. In the following description, “part” means “part by mass” and “%” means “mass %” unless otherwise specified. A numerical value in tables are solid content mass when there is no description of units, and blanks indicate no use.

The methods for measuring the average particle size of the inorganic filler and binder, and the glass transition temperature (Tg) of the binder are as follows.

### <Average Particle Size of Inorganic Filler>

The average particle size of inorganic filler is average particle size D₅₀ measured by dynamic light scattering. For the measurement, a dispersion was prepared by dispersing the inorganic filler in water 500 times the mass of inorganic filler, and using about 5 mL of the dispersion for the measurement with NANOTRAC (manufactured by NIKKISO Co., Ltd.)

### <Average Particle Size of Binder>

The average particle size of the binder is average particle size D₅₀ measured by dynamic light scattering. For the measurement, a diluted solution was prepared by diluting the aqueous binder dispersion with water by a factor of 500, and using about 5 mL of the diluted solution for the measurement with NANOTRAC (manufactured by NIKKISO Co., Ltd.).

### <Glass Transition Temperature (Tg)>

The glass transition temperature (Tg) was measured using a differential scanning calorimeter (DSC, manufactured by TA Instruments). Specifically, about 2 mg of a sample binder was weighed on an aluminum pan, the aluminum pan was set in a DSC measurement holder, and the baseline shift of the DSC curve obtained under a heating condition of 5° C./minute toward endothermic side (inflection point) was read to obtain Tg.

### Example A1

Into 100 parts of a monomer mixture solution at a ratio of 18.5% of methyl methacrylate, 77.2% of 2-ethylhexyl acrylate, 1.4% of acrylic acid, 0.4% of acrylamide, and 2.5% of 2-hydroxyethyl methacrylate, 48.5 parts of ion-exchanged water, 0.8 parts of Eleminol CLS-20 (anionic surfactant, manufactured by Sanyo Chemical Industries, Ltd.), and 2 parts of hexyltrimethoxysilane as silane compound (b) were added and stirred to prepare a pre-emulsion. Separately, a 2-liter four-necked flask equipped with a reflux condenser, a stirrer, a thermometer, a nitrogen inlet tube, and a raw material inlet was prepared as a reaction vessel, and the interior of the reaction vessel was replaced with nitrogen for 30 minutes. Then, the reaction vessel was charged with 94 parts of ion-exchanged water and 0.2 parts of Eleminol CLS-20 as anionic surfactant, and the mixture liquid was heated to 62° C. while stirring. After confirming that the liquid temperature was 62° C., the pre-emulsion, 0.3 parts of potassium persulfate and 0.1 parts of sodium metabisulfite were continuously added dropwise for 120 minutes. After completion of dropping, emulsion polymerization was continued for 30 minutes while the liquid temperature was maintained at 62° C. Then, the liquid temperature was cooled to 50° C., and 25% aqueous ammonia was added to adjust the pH to 8.5. The mixture was stirred for 5 minutes. The reaction solution was filtered through a 180-mesh polyester filter cloth to obtain a dispersion of binder A1. No aggregate remained on the filter cloth, and the polymerization stability was good. The resulting binder A1 dispersion had a non-volatile content of 40%, and the average particle size of the binder A1 was 140 nm.

### Examples A2 to A12, Comparative Examples A1 to A9

Binders A2 to A12 and A14 to A22 were obtained by synthesizing in the same manner as in Example A1, except that the compositions and amounts blended (parts by mass) were changed as shown in Tables 1 and 2.

### Example A13

Into 100 parts of a monomer mixture solution at a ratio of 77.2% of butyl acrylate, 20.0% of 2-ethylhexyl acrylate, 1.4% of acrylic acid, and 1.4% of acrylamide, 48.5 parts of ion-exchanged water and 0.8 parts of Hitenol NF-08 (anionic surfactant, manufactured by DKS Co., Ltd.) were added and stirred to prepare a pre-emulsion. Separately, a 2-liter four-necked flask equipped with a reflux condenser, a stirrer, a thermometer, a nitrogen inlet tube, and a raw material inlet was prepared as a reaction vessel, and the interior of the reaction vessel was replaced with nitrogen for 30 minutes. Then, the reaction vessel was charged with 94 parts of ion-exchanged water and 0.2 parts of Hitenol NF-08 as anionic surfactant, and the mixture liquid was heated to 62° C. while stirring. After confirming that the liquid temperature was 62° C., the pre-emulsion, 0.3 parts of potassium persulfate and 0.1 parts of sodium metabisulfite were continuously added dropwise for 120 minutes. After completion of dropping, emulsion polymerization was continued for 30 minutes while the liquid temperature was maintained at 62° C. Then, the liquid temperature was cooled to 50° C., and 25% aqueous ammonia was added to adjust the pH to 8.5. The mixture was stirred for 5 minutes. To the reaction liquid, 2.0 parts of KR-500 (manufactured by Shin-Etsu Chemical Co., Ltd.), which is the condensation product (B) of silane compound (b) represented by the general formula (1), was added, and the mixture was stirred at room temperature for 5 minutes. The mixture was then filtered through a 180-mesh polyester filter cloth to obtain a dispersion of binder A13. No aggregate remained on the filter cloth, and the polymerization stability was good. The resulting binder A13 dispersion had a non-volatile content of 40%, and the average particle size of the binder A13 was 160 nm.

TABLE 1

| | | Polymer | | | | | | | |
|---|---|---|---|---|---|---|---|---|---|
| | | Monomer (a1) | | | | Monomer (a2) | | | Monomer (a3) |
| | Binder | AA | MAA | NaSS | P-1A | AAm | MAAm | DMAAm | MMA |
| Example A1 | Binder A1 | 1.4 | | | | 0.4 | | | 18.5 |
| Example A2 | Binder A2 | 1 | | | 0.5 | | 2 | | 12.2 |
| Example A3 | Binder A3 | 2 | | | | 3 | | | 14.3 |
| Example A4 | Binder A4 | 0.4 | | | | 0.9 | | | 26.5 |
| Example A5 | Binder A5 | 1 | | | | [symbol] | | | [symbol] |
| Example A6 | Binder A6 | | 5 | | | | 1 | | 19.8 |
| Example A7 | Binder A7 | 1 | 1 | | | | | 2 | 40.5 |
| Example A8 | Binder A8 | 0.1 | 0.4 | | | 0.9 | | | 22 |
| Example A9 | Binder A9 | | | 0.4 | | 0.9 | | | 28 |
| Example A10 | Binder A10 | | 2 | | | 2 | | | 37.6 |
| Example A11 | Binder A11 | 0.4 | 1 | | | | | 0.4 | 60 |
| Example A12 | Binder A12 | 1 | | | | 1 | | | 24.2 |
| Example A13 | Binder A13 | 1.4 | | | | 1.4 | | | |
| Comparative | Binder A14 | 3 | | | | 3 | | | 32 |
| Example A1 | | | | | | | | | |
| Comparative | Binder A15 | 2 | | | | | | | 48 |
| Example A2 | | | | | | | | | |
| Comparative | Binder A16 | | | | | 1.5 | | | 50.5 |
| Example A3 | | | | | | | | | |
| Comparative | Binder A17 | | | | | | | | 35 |
| Example A4 | | | | | | | | | |
| Comparative | Binder A18 | | 1 | | | 3 | | | 80 |
| Example A5 | | | | | | | | | |
| Comparative | Binder A19 | 0.5 | | | | | 0.5 | | |
| Example A6 | | | | | | | | | |
| Comparative | Binder A20 | | 3 | | | | | | 24.3 |
| Example A7 | | | | | | | | | |
| Comparative | Binder A21 | 1 | | | | 0.4 | | | 83.2 |
| Example A8 | | | | | | | | | |
| Comparative | Binder A22 | 0.4 | | | | 0.9 | | | 26.5 |
| Example A9 | | | | | | | | | |

| | | Polymer | | | | | | |
|---|---|---|---|---|---|---|---|---|
| | | Monomer (a3) | | | Monomer (a4) | | | Monomer (a5) |
| | Binder | BA | 2EHA | LMA | GMA | DVB | γMPMS | 2HEMA |
| Example A1 | Binder A1 | | 77.2 | | | | | 2.5 |
| Example A2 | Binder A2 | 83.3 | | | 1 | | | |
| Example A3 | Binder A3 | | 49.9 | 27.8 | | 3 | | |
| Example A4 | Binder A4 | | 72.2 | | | | | |
| Example A5 | Binder A5 | | 26.9 | | | | | |
| Example A6 | Binder A6 | 25 | 49.2 | | | | | |
| Example A7 | Binder A7 | 55.5 | | | | | | |
| Example A8 | Binder A8 | | | 76.6 | | | | |
| Example A9 | Binder A9 | 21.3 | 49.4 | | | | | |
| Example A10 | Binder A10 | | 58.4 | | | | | |
| Example A11 | Binder A11 | | 38.2 | | | | | |
| Example A12 | Binder A12 | | 73.8 | | | | | |
| Example A13 | Binder A13 | 77.2 | 20 | | | | | |
| Comparative | Binder A14 | | 61.7 | | | | 0.3 | |
| Example A1 | | | | | | | | |
| Comparative | Binder A15 | 45 | | | | | | 5 |
| Example A2 | | | | | | | | |
| Comparative | Binder A16 | | 45 | | | 3 | | |
| Example A3 | | | | | | | | |
| Comparative | Binder A17 | | 60.5 | | 1.5 | | | 3 |
| Example A4 | | | | | | | | |
| Comparative | Binder A18 | 15.5 | | | | | 0.5 | |
| Example A5 | | | | | | | | |
| Comparative | Binder A19 | | 5 | 94 | | | | |
| Example A6 | | | | | | | | |
| Comparative | Binder A20 | 72.7 | | | | | | |
| Example A7 | | | | | | | | |
| Comparative | Binder A21 | 15.4 | | | | | | |
| Example A8 | | | | | | | | |
| Comparative | Binder A22 | | 72.2 | | | | | |
| Example A9 | | | | | | | | |

[symbol]

indicates data missing or illegible when filed

TABLE 2

| | | | | Other silane | Condensation | | Binder characteristics | |
|---|---|---|---|---|---|---|---|---|
| | | Silane compound (b) | | compound | product (B) | | Tg | Particle |
| | Binder | HTS-M | HTS-E | KBM-403 | KR-500 | Surfactant | [° C.] | size [nm] |
| Example A1 | Binder A1 | 2 | | | | Eleminol | −32 | 140 |
| Example A2 | Binder A2 | 2 | | | | CLS-20 | −31 | 180 |
| Example A3 | Binder A3 | | 2 | | | | −38 | 230 |
| Example A4 | Binder A4 | 2 | | | | Hitenol | −26 | 150 |
| Example A5 | Binder A5 | | 1 | | | NF-08 | 44 | 430 |
| Example A6 | Binder A6 | 0.5 | | | | | −25 | 130 |
| Example A7 | Binder A7 | 1 | | | | | 5 | 200 |
| Example A8 | Binder A8 | 2 | | | | | −40 | 150 |
| Example A9 | Binder A9 | | 2 | | | | −21 | 70 |
| Example A10 | Binder A10 | 0.1 | | | | | −9 | 130 |
| Example A11 | Binder A11 | 19.5 | | | | | 23 | 180 |
| Example A12 | Binder A12 | 2 | | | | PAASA | −28 | 110 |
| Example A13 | Binder A13 | | | | 2 | NF-08 | −44 | 160 |
| Comparative | Binder A14 | | | | | CLS-20 | −12 | 150 |
| Example A1 | | | | | | | | |
| Comparative | Binder A15 | 2 | | | | | 17 | 130 |
| Example A2 | | | | | | | | |
| Comparative | Binder A16 | | 1 | | | | 7 | 140 |
| Example A3 | | | | | | | | |
| Comparative | Binder A17 | | | | | | −13 | 180 |
| Example A4 | | | | | | | | |
| Comparative | Binder A18 | 0.5 | 0.5 | | | | 71 | 200 |
| Example A5 | | | | | | | | |
| Comparative | Binder A19 | 1 | | | | | −64 | 110 |
| Example A6 | | | | | | | | |
| Comparative | Binder A20 | | | | | NF-08 | −17 | 180 |
| Example A7 | | | | | | | | |
| Comparative | Binder A21 | 1 | | | | | 70 | 630 |
| Example A8 | | | | | | | | |
| Comparative | Binder A22 | | | 2 | | | −26 | 150 |
| Example A9 | | | | | | | | |

Abbreviations, etc. in the tables are as follows.

[Monomer (a1)]
AA: acrylic acid
MAA: methacrylic acid
NaSS: sodium styrene sulfonate
P-1A (N): 2-acryloyloxyethyl acid phosphate
   [Monomer (a2)]
AAm: acrylamide
MAAm: methacrylamide
DMAAm: N,N-dimethylacrylamide
   [Monomer (a3)]
MMA: methyl methacrylate
BA: butyl acrylate
2EHA: 2-ethylhexyl acrylate
LMA: dodecyl methacrylate
   [Monomer (a4)]
GMA: glycidyl methacrylate
DVB: divinylbenzene
γ-MPMS: γ-methacryloxy propyltrimethoxysilane
   [Monomer (a5)]
2HEMA: 2-hydroxyethyl methacrylate
   [Silane Compound (b)]
HTS-M: hexyltrimethoxysilane (In general formula (1), R¹ is a hexyl group, R² is a methyl group, and X is a methoxy group.)
HTS-E: hexyltriethoxysilane (In general formula (1), R¹ is a hexyl group, R² is an ethyl group, and X is an ethoxy group.)
   [Other Silane Compound (Silane Compound Other than Silane Compound (b))]
KBM-403: 3-glycidoxy propyltrimethoxysilane (manufactured by Shin-Etsu Chemical Co., Ltd.)

### [Condensation Product (B)]

KR-500: condensation product of methyltrimethoxysilane (manufactured by Shin-Etsu Chemical Co., Ltd.)

### [Surfactant]

Eleminol CLS-20: ammonium polyoxyalkylene alkyl ether sulfate (manufactured by Sanyo Chemical Industries, Ltd.)
Hitenol NF-08: polyoxyethylene alkyl ether sulfate (manufactured by DKS Co., Ltd.)
PAASA: polyoxyethylene-1-(allyloxy methyl)alkyl ether ammonium sulfate (reactive anionic surfactant)

### Example A14

### (Preparation of Resin Composition)

Into a bead mill, 50.0 parts of alumina particles having an average particle size of 0.5 μm as inorganic filler, 0.5 parts of ammonium polycarboxylate (BYK-154) as dispersing agent, and 42.7 parts of water were fed to prepare an alumina dispersion. To the resulting alumina dispersion, 1.0 part of binder A1 in terms of solid content, 0.6 parts of 4% aqueous solution of carboxymethyl cellulose (CMC, Daicel 1220) as thickener, 0.3 parts of a silicon-based activator (BYK-349) as wetting agent, and 0.2 parts of silicon-based antifoaming agent (BYK-018) were added. Water was added thereto to have a solid concentration of 43%, and mixed to prepare a resin composition for a non-aqueous secondary battery separator.

(Preparation of Separator with Protective Layer)

A protective layer formed from the resin composition was applied to one side of a separator substrate (9 μm thick, porous polyethylene film) using a doctor blade so as to have a thickness of 3 μm. The protective layer was then dried in an oven at 80° C., so that a separator with a protective layer was obtained.

### (Preparation of Battery)

### Preparation of Positive Electrode

A mixture ink for positive electrode was prepared by mixing 93 parts of LiNi_{0.5}Mn_{0.3}Co_{0.2}O₂ as positive electrode active material, 4 parts of acetylene black as conductive agent, 3 parts of polyvinylidene fluoride as binder, and 45 parts of N-methylpyrrolidone in a container. The resulting mixture ink for positive electrode was applied to an aluminum foil having a thickness of 20 μm to make a current collector using a doctor blade, and then dried at 80° C. by heating, such that the basis weight per unit area of the electrode was controlled to 20 mg/cm². Further, rolling treatment was performed by a roll press, so that a positive electrode having a mixture layer density of 3.1 g/cm³ was prepared.

### Preparation of Negative Electrode

In a planetary mixer, a mixture ink for negative electrode was prepared by kneading 98 parts of artificial graphite as negative electrode active material and 66.7 parts of 1.5% carboxymethyl cellulose aqueous solution (1 part as solid content) and then mixing with 33 parts of water and 2.08 parts of the aqueous dispersion of 48% of styrene-butadiene emulsion (1 part as solid content). The resulting mixture ink for negative electrode was applied to a copper foil having a thickness of 20 μm to make a current collector using a doctor blade, and then dried at 80° C. by heating, such that the basis weight per unit area of the electrode was controlled to 12 mg/cm². Further, rolling treatment was performed by a roll press, so that a negative electrode having a mixture layer density of 1.5 g/cm³ was prepared.

### Preparation of Battery

A positive electrode and a negative electrode were cut into sizes of 45 mm×40 mm and 50 mm×45 mm, respectively. The positive electrode and the negative electrode placed facing each other through the separator with the protective layer were inserted into an aluminum laminate bag, and vacuum dried. Then, an electrolytic solution (non-aqueous electrolytic solution obtained by dissolving LiPF₆ at a concentration of 1 M in a mixture solvent of ethylene carbonate and diethyl carbonate at a volume ratio of 2:3) was injected into the bag, and the aluminum laminate was sealed to prepare a laminate-type non-aqueous secondary battery.

### Examples A15 to A26 and Comparative Examples A10 to A18

A separator with protective layer, a positive electrode and a negative electrode were prepared in the same manner as in Example A14, except that the resin composition for a non-aqueous secondary battery separator shown in Table 3 was used, so that a non-aqueous secondary battery was obtained.

Based on the resulting resin composition, the solution stability was evaluated. Based on the separator with protective layer, flexibility, adhesion, resistance to electrolytic solution, and heat resistance were evaluated. Based on the non-aqueous secondary battery, the cycle characteristics were evaluated. The evaluations were performed by the following methods, respectively. The results are shown in Table 3.

### (Evaluation of Resin Composition)

### <Solution Stability>

The resulting resin composition for a non-aqueous secondary battery separator was stored at 25° C., and the presence or absence of aggregation, sedimentation and separation was visually observed to evaluate solution stability based on the following evaluation criteria.

### [Evaluation Criteria]

A (good): No abnormalities were observed in the resin composition for a non-aqueous secondary battery separator for two weeks or more after the start of storage.
B (acceptable): Some abnormalities were observed in the resin composition for a non-aqueous secondary battery separator during one to two weeks from the start of storage.
C (unacceptable): Some abnormalities were observed in the resin composition for a non-aqueous secondary battery separator within one week from the start of storage.
   (Evaluation of Separator with Protective Layer)

### <Flexibility>

The resulting separator with protective layer was cut into sizes of 10 mm wide×50 mm long to prepare a sample. The sample was wound around a metal rod with a diameter of 1.5 mm so that the current collector was in contact with the sample. In that state, the surface condition of the protective layer was visually observed, and the flexibility was evaluated based on the following evaluation criteria.

### [Evaluation Criteria]

A (good): No change was observed on the surface of the protective layer.
B (acceptable): Some changes were observed on a part of the surface of the protective layer.
C (unacceptable): Cracks were observed on the surface of the protective layer.

### <Adhesion>

The resulting separator with a protective layer was cut into sizes of 25 mm wide×100 mm long, and the substrate side of the separator and a stainless steel plate were stuck together with a double-sided adhesive tape. A cellophane tape with a width of 18 mm was attached to the surface on the protective layer-side, and roll-pressure bonded with a load of 1 kg. After standing still for 24 hours at a temperature of 25° C. and a humidity of 50%, one end of the cellophane tape was pulled in a direction of 180°, so that the peel strength was measured with a tensile tester AGS-X (manufactured by Shimadzu Corporation) (peeling speed: 10 mm/min, unit: N/18 mm width). The higher the peel strength, the better the adhesion.

### [Evaluation Criteria]

S (excellent): The peel strength is 2.0 N/18 mm or more.
A (good): The peel strength is 1.5 N/18 mm or more and less than 2.0 N/18 mm.
B (acceptable): The peel strength is 1.0 N/18 mm or more and less than 1.5 N/18 mm.
C (unacceptable): The peel strength is less than 1.0 N/18 mm.

### <Resistance to Electrolytic Solution 1>

The resulting separator with protective layer was immersed in a mixture solvent of ethylene carbonate:diethyl carbonate=2:3 (volume ratio) at 60° C. for 48 hours. After the immersion, the mixture solvent remaining on the surface of the separator was washed off with methanol, and the separator was then dried at room temperature under reduced pressure conditions until complete drying. The dried separator was cut into sizes of 25 mm wide×100 mm long, and the peel strength of the separator was measured in the same manner as the adhesion evaluation described above. From the peel strength results before and after immersion, the rate of change in peel strength was calculated using the following formula.

$$Rate of change in peel strength ( \% ) = [ \text{} ( Peel strength before immersion ) - ( Peel strength after immersion ) ] / ( Peel strength before immersion ) \times 100$$

### [Evaluation Criteria]

A (good): Rate of change in peel strength is less than 1%.
B (acceptable): Rate of change in peel strength is 1% or more and less than 3%.
C (unacceptable): Rate of change in peel strength is 3% or more.

### <Heat Resistance>

The heat resistance of the separator was evaluated by the following method. The separator was cut into sizes of 100 mm in MD (flow direction)×100 mm in TD (perpendicular direction) to obtain a sample. The sample was inserted in three sheets of paper and placed in an oven at 150° C. for 1 hour. After cooling of the samples taken out from the oven, the shrinkage rate was calculated as follows.

$$Sample area ( {mm}^{2} ) = ( MD length of sample ) \times ( TD length of sample )$$

$$Shrinkage rate ( \% ) = [ \text{} 1 - ( Sample area after heating ) / ( Sample area before heating ) ] \times 100$$

### [Evaluation Criteria]

A (Good): Shrinkage rate is less than 10%.
B (acceptable): The shrinkage rate is 10% or more and less than 15%.
C (unacceptable): The shrinkage rate is 15% or more.

### (Non-Aqueous Secondary Battery)

### <Cycle Characteristics>

After constant current constant voltage charging (cutoff current: 0.6 mA) at a charging current of 60 mA and a charging end voltage of 4.2 V in a thermostatic chamber at 50° C., constant current discharging was performed until the charging end voltage reached 3.0 V at a discharging current of 60 mA, so that the initial discharge capacity was determined. The charge/discharge cycle was repeated 1200 times, so that the discharge capacity retention rate (percentage of discharge capacity at 1200th cycle relative to initial discharge capacity) was calculated. It can be said that the higher the discharge capacity retention rate, the better the cycle characteristics.

### [Evaluation Criteria]

A (good): The discharge capacity retention rate is 90% or more.
B (acceptable): The discharge capacity retention rate is 85% or more and less than 90%.
C (unacceptable): The discharge capacity retention rate is less than 85%.

TABLE 3

| | | Resin | Separator with protective layer | | | | Non-aqueous |
|---|---|---|---|---|---|---|---|
| | | composition | | | Resistance to | | secondary battery |
| | | Solution | | | electrolytic | Heat | Cycle |
| | Binder | stability | Flexibility | Adhesion | solution 1 | resistance | characteristics |
| Example A14 | Binder A1 | A | A | S | A | A | A |
| Example A15 | Binder A2 | A | A | B | A | B | B |
| Example A16 | Binder A3 | A | A | B | A | B | B |
| Example A17 | Binder A4 | A | A | S | A | A | A |
| Example A18 | Binder A5 | B | B | A | B | A | A |
| Example A19 | Binder A6 | A | A | A | B | A | A |
| Example A20 | Binder A7 | B | A | S | B | A | A |
| Example A21 | Binder A8 | A | A | S | A | A | A |
| Example A22 | Binder A9 | B | A | A | B | A | A |
| Example A23 | Binder A10 | A | A | S | A | A | A |
| Example A24 | Binder A11 | B | B | S | B | A | A |
| Example A25 | Binder A12 | A | A | S | A | A | A |
| Example A26 | Binder A13 | A | A | B | A | B | B |
| Comparative | Binder A14 | B | A | C | B | C | C |
| Example A10 | | | | | | | |
| Comparative | Binder A15 | C | B | C | C | C | C |
| Example A11 | | | | | | | |
| Comparative | Binder A16 | B | C | C | C | C | C |
| Example A12 | | | | | | | |
| Comparative | Binder A17 | B | B | C | C | C | C |
| Example A13 | | | | | | | |
| Comparative | Binder A18 | C | C | C | B | C | C |
| Example A14 | | | | | | | |
| Comparative | Binder A19 | B | A | C | B | C | C |
| Example A15 | | | | | | | |
| Comparative | Binder A20 | C | B | C | C | C | C |
| Example A16 | | | | | | | |
| Comparative | Binder A21 | B | C | C | B | C | C |
| Example A17 | | | | | | | |
| Comparative | Binder A22 | B | B | C | B | C | C |
| Example A18 | | | | | | | |

As shown in Table 3, the resin composition for a non-aqueous secondary battery separator made from the binder for a non-aqueous secondary battery separator of the present disclosure has excellent solvent stability, and the separator having a protective layer formed from the resin composition is very excellent in flexibility, adhesion, resistance to electrolytic solution, and heat resistance. It has been confirmed that due to having such a non-aqueous secondary battery separator, a non-aqueous secondary battery good in cycle characteristics can be obtained. In particular, the protective layer formed from the resin composition for a non-aqueous secondary battery separator of the present disclosure exhibits a remarkable effect of having excellent resistance to electrolytic solution and heat resistance even in the case of a thin film.

### Example B

The present disclosure will be described in more detail with reference to Example B in the following, though the present disclosure is not limited thereto. In the following description, “part” means “part by mass” and “%” means “mass %” unless otherwise specified. Numerical values in the tables represent parts by mass of solid content in the case where no unit is described, and blanks represent no use. Descriptions similar to those in Example A may be omitted to avoid repetition.

The methods for measuring the average particle size of the inorganic filler and binder, and the glass transition temperature (Tg) and acid value of the resin are as follows.

### <Average Particle Size of Inorganic Filler>

An image of the inorganic filler particles observed by a scanning electron microscope (SEM) JSM-7800F (manufactured by JEOL Ltd.) at a magnification of 15000 was introduced into an image processing software Winroof (manufactured by Mitani Corporation) to extract the spherical structure. The average particle size of the inorganic filler was calculated based on the measurement of the average equivalent circle diameter of individual particles.

### <Average Particle Size of Binder>

The average particle size of the binder in an aqueous binder dispersion is average particle size D₅₀ obtained by dynamic light scattering measurement. The measurement was performed by preparing a diluted solution by diluting the aqueous binder dispersion with water by a factor of 500, and using about 5 mL of the diluted solution for the measurement with Nanotrac Wave II EX150 (manufactured by Microtrac Bel Co., Ltd.).

### <Glass Transition Temperature (Tg)>

The glass transition temperature (Tg) was measured using a differential scanning calorimeter (DSC, manufactured by TA Instruments). Specifically, about 2 mg of the binder solution as a sample was weighed on an aluminum pan, the aluminum pan was set in a DSC measurement holder, and the endothermic peak obtained under a heating condition of 5° C./minute was defined as Tg.

### <Acid Value>

The acid value was calculated by potentiometric titration with a potassium hydroxide/ethanol solution in accordance with JIS K2501. In the titration, an automatic titrator COM-1600 (manufactured by HIRANUMA Co., Ltd.) was used.

### <Method for Calculating Log Kow>

The log Kow values of a monomer (c) and a complete hydrolysate of the alkoxy monosilane compound (d) were calculated by YMB method (physical property estimation function) of Hansen solubility parameter software HSPiP (ver.5.2.05), in which the structural formulas of the compounds converted into SMILES notation were inputted.

### Example B1

Into 100 parts of an ethylenically unsaturated monomer mixture including 1.0 part of methacrylic acid as monomer (c1), 1.0 part of acryl amide as monomer (c2), 5.0 parts of styrene as monomer (c3), 23.0 parts of methyl methacrylate, 20.0 parts of 2-ethylhexyl acrylate, and 50.0 parts of butyl acrylate, 34.0 parts of water, 4.8 parts (active ingredient content: 0.96 parts) of 20% Eleminol CLS-20 aqueous solution (polyoxyalkylene alkyl ether ammonium sulfate, manufactured by Sanyo Chemical Industries, Ltd.) as anionic surfactant, and 3.0 parts of octyl triethoxysilane as alkoxy monosilane compound (d) were added and stirred to prepare an emulsion for use in a titration tank. Separately, a 2-liter four-necked flask equipped with a reflux condenser, a stirrer, a thermometer, a nitrogen inlet tube, and a raw material inlet was prepared as a reaction vessel. Then, the reaction vessel was charged with 95 parts of water, 1.2 parts (active ingredient content: 0.24 parts) of 20% Hitenol NF-08 aqueous solution (polyoxyethylene alkyl ether sulfate, manufactured by DKS Co., Ltd.) as anionic surfactant, and 7.0 part of the emulsion prepared as above. The mixture was stirred while replacing with nitrogen, and internal temperature was raised to 75° C. After the temperature rise, 7.5 parts of 3.5% potassium persulfate aqueous solution was added. While maintaining the internal temperature at 80° C., the remaining emulsion was added dropwise over a period of 3 hours. After completion of dropping, the internal temperature was further maintained at 80° C. for 4 hours and then the reaction was completed. After the reaction, the internal temperature was lowered to less than 40° C. by cooling, and 25% ammonia water was added to achieve 100% neutralization of the carboxy group of the polymer. Further, water was added thereto to adjust the solid concentration of the binder to 40.0 mass %, so that an aqueous dispersion of the binder was obtained.

### Examples B2 to B25 and Comparative Examples B1 to B5

An aqueous dispersion of the binder was obtained by performing resin synthesis in the same manner as in Example B1 except that the composition and the amount blended (parts by mass) were changed to each of those shown in Tables 4 to 6. In Examples B16 and B17, the amount of 20% Hitenol NF-08 aqueous solution fed to the reaction vessel was changed to 2.4 parts from 1.2 parts, and in Examples B21 and B22, the amount of 20% Hitenol NF-08 aqueous solution fed to the reaction vessel was changed to 0.2 parts from 1.2 parts, and the amount of 20% Eleminol CLS-20 aqueous solution fed to the dropping tank was changed to 2.8 parts from 4.8 parts, respectively.

TABLE 4

| | | | Partition coefficient log | | | | |
|---|---|---|---|---|---|---|---|
| | | Partition coefficient | [symbol] of complete | | | | |
| | | log [symbol] of monomer | [symbol] of [symbol] | Example | Example | Example | Example |
| | | (c3) | monosilane | B1 | B2 | B3 | B4 |
| [symbol] having acidic | [symbol] acid | | | 1.0 | | | [symbol] |
| group (c1) | Acrylic acid | | | | 0.5 | 2.0 | |
| Monomer having [symbol] | Diacetone acrylamide | | | | | [symbol] | |
| group (c2) | Acrylamide | | | [symbol] | [symbol] | | |
| Monomer other than (c1) | Styrene | [symbol] | | [symbol] | | | [symbol] |
| and (c2) | Benzyl methacrylate | [symbol] | | | | [symbol] | |
| | [symbol] acrylate | [symbol] | | | | 10.0 | |
| | Methyl methacrylate | [symbol] | | 23.0 | 27.0 | | 23.0 |
| | Butyl methacrylate | [symbol] | | | | 24.0 | |
| | 2-Ethylhexyl acrylate | [symbol] | | 20.0 | 71.5 | | 20.0 |
| | Cyclohexyl [symbol] | [symbol] | | | | [symbol] | |
| | Butyl acrylate | [symbol] | | 50.0 | | 17.0 | 50.0 |
| | Ethyl acrylate | [symbol] | | | | 20.0 | |
| | 2- [symbol] methacrylate | [symbol] | | | | 1.0 | |
| | [symbol] acrylate | [symbol] | | | | | |
| | [symbol] | [symbol] | | | | 7.0 | |
| | [symbol] methacrylate | [symbol] | | | | | |
| Alkyl group-containing | Propyl [symbol] | | [symbol] | | | | |
| [symbol] monosilane (d1) | [symbol] | | [symbol] | | | 4.0 | |
| | [symbol] | | [symbol] | | | | |
| | [symbol] | | [symbol] | | 2.0 | | |
| | [symbol] | | [symbol] | 3.0 | | | 3.0 |
| | [symbol] | | [symbol] | | | | |
| | [symbol] | | [symbol] | | | | |
| | [symbol] | | [symbol] | | | | |
| [symbol] other | Ethyl [symbol] | | [symbol] | | | | |
| than (d1) | Vinyl [symbol] | | [symbol] | | | | |
| | Octenyl [symbol] | | [symbol] | | | | |
| | γ- [symbol] | | [symbol] | | | | |
| | [symbol] | | [symbol] | | | | |
| Binder | Acid value [symbol] | | | [symbol] | 3.9 | [symbol] | [symbol] |
| characteristics | Tg [° C.] | | | [symbol] | [symbol] | [symbol] | [symbol] |
| | Particle size [nm] | | | 155 | 170 | [symbol] | 153 |

| | | Example | Example | Example | Example | Example | Example |
|---|---|---|---|---|---|---|---|
| | | B5 | B6 | B7 | B8 | B9 | B10 |
| [symbol] having acidic | [symbol] acid | 1.0 | | 1.0 | [symbol] | [symbol] | |
| group (c1) | Acrylic acid | | | | [symbol] | [symbol] | [symbol] |
| Monomer having [symbol] | Diacetone acrylamide | | | | | | |
| group (c2) | Acrylamide | [symbol] | [symbol] | [symbol] | [symbol] | [symbol] | [symbol] |
| Monomer other than (c1) | Styrene | [symbol] | [symbol] | [symbol] | | | [symbol] |
| and (c2) | Benzyl methacrylate | | | | | | |
| | [symbol] acrylate | | | | | | |
| | Methyl methacrylate | 23.0 | [symbol] | 23.0 | [symbol] | [symbol] | 20.0 |
| | Butyl methacrylate | | | | | | |
| | 2-Ethylhexyl acrylate | 20.0 | 20.0 | 20.0 | | | 30.0 |
| | Cyclohexyl [symbol] | | | | | | |
| | Butyl acrylate | 50.0 | 50.0 | 50.0 | 47.0 | 43.0 | |
| | Ethyl acrylate | | | | 10.5 | 10.5 | |
| | 2- [symbol] methacrylate | | | | | | |
| | [symbol] acrylate | | | | 36.0 | 40.0 | |
| | [symbol] | | | | | | |
| | [symbol] methacrylate | | | | | | [symbol] |
| Alkyl group-containing | Propyl [symbol] | | | [symbol] | | | |
| [symbol] monosilane (d1) | [symbol] | | | | | | |
| | [symbol] | | | | | | |
| | [symbol] | | | | | | |
| | [symbol] | | 3.0 | | | | |
| | [symbol] | | | | | | [symbol] |
| | [symbol] | | | | 1.0 | 1.0 | |
| | [symbol] | 3.0 | | | | | |
| [symbol] other | Ethyl [symbol] | | | | | | |
| than (d1) | Vinyl [symbol] | | | | | | |
| | Octenyl [symbol] | | | | | | |
| | γ- [symbol] | | | | | | |
| | [symbol] | | | | | | |
| Binder | Acid value [symbol] | [symbol] | [symbol] | [symbol] | [symbol] | [symbol] | [symbol] |
| characteristics | Tg [° C.] | [symbol] | [symbol] | [symbol] | [symbol] | [symbol] | [symbol] |
| | Particle size [nm] | 172 | [symbol] | 158 | [symbol] | [symbol] | 230 |

[symbol]

indicates data missing or illegible when filed

TABLE 5

| | | [symbol] | [symbol] | Example [symbol] | Example [symbol] | Example [symbol] | Example [symbol] | Example [symbol] |
|---|---|---|---|---|---|---|---|---|
| Monomer having [symbol] | [symbol] | | | | | | [symbol] | [symbol] |
| group (c1) | [symbol] acid | | | [symbol] | [symbol] | [symbol] | | |
| Monomer having [symbol] | [symbol] acrylamide | | | [symbol] | [symbol] | [symbol] | | |
| group (c2) | [symbol] | | | [symbol] | [symbol] | [symbol] | [symbol] | [symbol] |
| [symbol] | Styrene | [symbol] | | [symbol] | [symbol] | [symbol] | [symbol] | [symbol] |
| | [symbol] | [symbol] | | | | | | |
| | [symbol] | [symbol] | | | | | | |
| | [symbol] | [symbol] | | [symbol] | [symbol] | [symbol] | [symbol] | [symbol] |
| | [symbol] | [symbol] | | | [symbol] | [symbol] | | |
| | [symbol] | [symbol] | | [symbol] | [symbol] | [symbol] | [symbol] | [symbol] |
| | [symbol] | [symbol] | | | | | | |
| | [symbol] | [symbol] | | | [symbol] | [symbol] | [symbol] | [symbol] |
| | [symbol] | [symbol] | | | [symbol] | [symbol] | | |
| | [symbol] | [symbol] | | | | | | |
| | [symbol] | [symbol] | | | | | | |
| | [symbol] | [symbol] | | | | | | |
| | [symbol] | | | [symbol] | | | | |
| Alkyl group-containing | [symbol] | | [symbol] | | | | | |
| [symbol] | [symbol] | | [symbol] | | | | | |
| | [symbol] | | [symbol] | | | | [symbol] | [symbol] |
| | [symbol] | | [symbol] | | | | | |
| | [symbol] | | [symbol] | | [symbol] | [symbol] | | |
| | [symbol] | | [symbol] | [symbol] | | | | |
| | [symbol] | | [symbol] | | | | | |
| | [symbol] | | [symbol] | | | | | |
| [symbol] other | [symbol] | | [symbol] | | | | | |
| than ( [symbol] ) | [symbol] | | [symbol] | | | | | |
| | [symbol] | | [symbol] | | | | | |
| | [symbol] | | [symbol] | | | | | |
| | [symbol] | | [symbol] | | | | | |
| | [symbol] | | | [symbol] | [symbol] | [symbol] | [symbol] | [symbol] |
| [symbol] | Tg [° C.] | | | [symbol] | [symbol] | [symbol] | [symbol] | [symbol] |
| | Particle size [nm] | | | [symbol] | [symbol] | [symbol] | [symbol] | [symbol] |

| | | Example [symbol] | Example [symbol] | Example [symbol] | Example [symbol] | Example [symbol] |
|---|---|---|---|---|---|---|
| Monomer having [symbol] | [symbol] | [symbol] | [symbol] | [symbol] | [symbol] | |
| group (c1) | [symbol] acid | | | [symbol] | [symbol] | [symbol] |
| Monomer having [symbol] | [symbol] acrylamide | | | | | |
| group (c2) | [symbol] | [symbol] | [symbol] | [symbol] | [symbol] | [symbol] |
| [symbol] | Styrene | | | | | |
| | [symbol] | [symbol] | [symbol] | | | |
| | [symbol] | | | | | |
| | [symbol] | [symbol] | [symbol] | [symbol] | [symbol] | [symbol] |
| | [symbol] | | | | | |
| | [symbol] | [symbol] | [symbol] | [symbol] | [symbol] | [symbol] |
| | [symbol] | | | | | |
| | [symbol] | [symbol] | [symbol] | | | |
| | [symbol] | | | | | |
| | [symbol] | [symbol] | [symbol] | [symbol] | [symbol] | |
| | [symbol] | | | | | |
| | [symbol] | | | | | |
| | [symbol] | | | | | |
| Alkyl group-containing | [symbol] | | | | | |
| [symbol] | [symbol] | | | | | |
| | [symbol] | | | | | |
| | [symbol] | | | | | [symbol] |
| | [symbol] | [symbol] | [symbol] | | | |
| | [symbol] | | | | | [symbol] |
| | [symbol] | | | [symbol] | [symbol] | |
| | [symbol] | | | | | |
| [symbol] other | [symbol] | | | | | |
| than ( [symbol] ) | [symbol] | | | | | |
| | [symbol] | | | | | |
| | [symbol] | | | | | |
| | [symbol] | | | | | |
| | [symbol] | [symbol] | [symbol] | [symbol] | [symbol] | [symbol] |
| [symbol] | Tg [° C.] | [symbol] | [symbol] | [symbol] | [symbol] | [symbol] |
| | Particle size [nm] | [symbol] | [symbol] | [symbol] | [symbol] | [symbol] |

[symbol]

indicates data missing or illegible when filed

TABLE 6

| | | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|
| [symbol] | [symbol] | | | | | | | | [symbol] | [symbol] | [symbol] | [symbol] | [symbol] |
| | [symbol] | | | [symbol] | [symbol] | [symbol] | [symbol] | [symbol] | | | | | |
| [symbol] | [symbol] | | | | | | | | | | | | |
| | [symbol] | | | [symbol] | [symbol] | [symbol] | [symbol] | [symbol] | [symbol] | [symbol] | [symbol] | [symbol] | [symbol] |
| [symbol] | Styrene | [symbol] | | | | [symbol] | [symbol] | [symbol] | [symbol] | [symbol] | [symbol] | [symbol] | [symbol] |
| | [symbol] | [symbol] | | | | | | | | | | | |
| | [symbol] | [symbol] | | | | | | | | | | | |
| | [symbol] | [symbol] | | [symbol] | [symbol] | [symbol] | [symbol] | [symbol] | [symbol] | [symbol] | [symbol] | [symbol] | [symbol] |
| | [symbol] | [symbol] | | | | [symbol] | | [symbol] | | | | | |
| | [symbol] | [symbol] | | [symbol] | [symbol] | [symbol] | [symbol] | [symbol] | [symbol] | [symbol] | [symbol] | [symbol] | [symbol] |
| | [symbol] | [symbol] | | | | | | | | | | | |
| | [symbol] | [symbol] | | [symbol] | [symbol] | [symbol] | [symbol] | [symbol] | [symbol] | [symbol] | [symbol] | [symbol] | [symbol] |
| | [symbol] | [symbol] | | | | [symbol] | [symbol] | [symbol] | | | | | |
| | [symbol] | [symbol] | | | | | | | | | | | |
| | [symbol] | [symbol] | | | | | | | | | | | |
| | [symbol] | [symbol] | | [symbol] | [symbol] | | | | | | | | |
| | [symbol] | [symbol] | | | | | | | | | | | |
| [symbol] | [symbol] | | [symbol] | | | | | | | | | | |
| | [symbol] | | [symbol] | | | | | | | | | | |
| | [symbol] | | [symbol] | | | | | | | | | | |
| | [symbol] | | [symbol] | | | | | | | | | | |
| | [symbol] | | [symbol] | | | [symbol] | [symbol] | [symbol] | | | | | |
| | [symbol] | | [symbol] | [symbol] | [symbol] | | | | | | | | |
| | [symbol] | | [symbol] | | | | | | | | | | |
| | [symbol] | | [symbol] | | | | | | | | | | |
| [symbol] | [symbol] | | [symbol] | | | | | | [symbol] | | | | |
| | [symbol] | | [symbol] | | | | | | | [symbol] | | | |
| | [symbol] | | [symbol] | | | | | | | | [symbol] | | |
| | [symbol] | | [symbol] | | | | | | | | | [symbol] | |
| | [symbol] | | [symbol] | | | | | | | | | | [symbol] |
| [symbol] | [symbol] | | | [symbol] | [symbol] | [symbol] | [symbol] | [symbol] | [symbol] | [symbol] | [symbol] | [symbol] | [symbol] |
| | [symbol] | | | [symbol] | [symbol] | [symbol] | [symbol] | [symbol] | [symbol] | [symbol] | [symbol] | [symbol] | [symbol] |
| | [symbol] | | | [symbol] | [symbol] | [symbol] | [symbol] | [symbol] | [symbol] | [symbol] | [symbol] | [symbol] | [symbol] |

[symbol]

indicates data missing or illegible when filed

### Example B26

### (Preparation of Resin Composition)

Into a bead mill, 50.0 parts of alumina particles having an average particle size of 0.5 μm as inorganic filler, 0.5 parts of BYK-154 (ammonium salt of acrylic-based copolymer, manufactured by BYK Japan KK) as dispersing agent, and 42.7 parts of water were fed to prepare an alumina dispersion. To the resulting alumina dispersion, 1.0 part of the aqueous binder dispersion prepared in Example B1 in terms of solid content, 0.6 parts of 4% aqueous solution of CMC Daicel 1220 (4% sodium carboxymethyl cellulose aqueous solution, manufactured by Daicel Miraizu Ltd.) as thickener, 0.2 parts of BYK-349 (polyether modified siloxane, manufactured by BYK Japan KK) as wetting agent, 0.2 parts of BYK-018 (mixture of foam-breaking polysiloxane and hydrophobic particles, manufactured by BYK Japan KK) as antifoaming agent, and 1.0 part of isopropyl alcohol were added, and water was further added thereto to have a solid concentration of 43%. The mixture was mixed to prepare a resin composition.

### (Preparation of Separator)

The resin composition was applied to one side of a separator substrate (8 μm thickness, porous polyethylene film) using a doctor blade to form a protective layer having a thickness of 3 μm after drying. The layer was then dried in an oven at 80° C. for 5 minutes to prepare a separator with a protective layer on one side of the separator substrate.

### (Preparation of Battery)

### Preparation of Positive Electrode

A mixture ink for positive electrode was prepared by mixing 93 parts of LiNi_{0.5}Mn_{0.3}Co_{0.2}O₂ as positive electrode active material, 4 parts of Denka Black HS100 (acetylene black, manufactured by Denka C., Ltd.) as conductive agent, 3 parts of Kureha KF polymer W #1300 (polyvinylidene fluoride, manufactured by Kureha Battery Materials Japan Co., Ltd.) as binder resin and 45 parts of N-methylpyrrolidone. The resulting mixture ink for positive electrode was applied to an aluminum foil having a thickness of 20 μm to make a current collector using a doctor blade so as to have a basis weight after drying of 20 mg/cm², and then dried at 80° C. by heating. Further, rolling treatment was performed by a roll press, so that a positive electrode having a mixture layer density of 3.1 g/cm³ was prepared.

### Preparation of Negative Electrode

In a planetary mixer, a mixture ink for negative electrode was prepared by kneading 98 parts of CGB-20 (artificial graphite, manufactured by Nippon Graphite Industries, Co., Ltd.) as negative electrode active material and 66.7 parts of 1.5% MAC500LC (sodium carboxymethyl cellulose, manufactured by Nippon Paper Industries Co., Ltd.) aqueous solution (1 part as solid content) and then mixing with 33 parts of water and 2.08 parts (1 part as solid content) of the aqueous dispersion of 48% of TRD2001 (styrene-butadiene emulsion, manufactured by JSR Corporation). The resulting mixture ink for negative electrode was applied to a copper foil having a thickness of m to make a current collector using a doctor blade, such that the basis weight was controlled to 12 mg/cm² after drying. The ink was then dried at 80° C. by heating. Further, rolling treatment was performed by a roll press, so that a negative electrode having a mixture layer density of 1.5 g/cm³ was prepared.

### Preparation of Battery

A positive electrode and a negative electrode were cut into sizes of 45 mm×40 mm and 50 mm×45 mm, respectively. The cut positive electrode and the negative electrode placed facing each other through the separator were inserted into an aluminum laminate bag, and the internal part of the bag was vacuum dried. Subsequently, an electrolytic solution (solution obtained by dissolving LiPF₆ at a concentration of 1 M in a mixture solvent of ethylene carbonate and diethyl carbonate at a volume ratio of 2:3) was injected into the bag, and then the bag was sealed to prepare a laminate-type non-aqueous secondary battery as an aspect of the electricity storage device.

### Examples B27 to B50 and Comparative Examples B6 to B10

A resin composition, a separator, a positive electrode, and a negative electrode were prepared in the same manner as in Example B26 so as to prepare each of the non-aqueous secondary batteries, except that the aqueous binder dispersion prepared in Example B1 was changed to the aqueous binder dispersion shown in Table 7. Furthermore, regarding the resin composition for forming a protective layer after accelerated over time to be described later, a separator with protective layer, a positive electrode and a negative electrode were prepared in the same manner to prepare the non-aqueous secondary battery.

### (Evaluation of Resin Composition)

### <Stability Over Time>

The resin composition immediately after preparation in Example B26 (referring to this resin composition as “resin composition before acceleration”) was placed in a glass container, sealed, and stored in a dark place at 60° C. for 3 months (referring to this resin composition as “resin composition after acceleration”). Then, the temperature in the container was adjusted to 25° C., and the container was shaken to observe the state of the resin composition in the container. Each of the samples of the resin compositions before and after storage diluted with water by a factor of 500 was measured with a laser diffraction/scattering particle size distribution analyzer (particle size distribution analyzer MT3000, manufactured by Microtrac Bel Co., Ltd.). From the value of the average particle size obtained, the rate of change in the average particle size was calculated according to the following formula. The smaller the rate of change in the average particle size, the better the dispersion state and the better the stability over time.

$$Rate of change in average particle \text{} size ( \% ) = [ ( Average particle size before storage ) - ( Average particle size after storage ) / ( Average particle size before storage ) ] \times 100$$

### [Evaluation Criteria]

S (excellent): Rate of change in average particle size is within ±5%.
A (good): The rate of change in average particle size is −10% or more and less than −5%, or more than 5% and 10% or less.
B (acceptable): The rate of change in average particle size is −15% or more and less than −10%, or more than 10% and 15% or less.
C (unacceptable): The rate of change in average particle size is less than −15% or more than 15%, or aggregates are formed in the resin composition and no redispersion occurs.

### (Evaluation of Separator)

### <Flexibility>

A separator was prepared from the resin composition before acceleration by the method described above, and cut into sizes of 10 mm wide×50 mm long to make a sample. The sample was wrapped around a metal rod having a diameter of 1.2 mmφ and kept in the state for 1 hour. After 1 hour, the separator was removed from the metal bar and the surface condition of the protective layer (10 mm wide×50 mm long portion) was visually observed to evaluate flexibility based on the following evaluation criteria. A separator was prepared from the resin composition after acceleration also in the same manner to evaluate the flexibility. The smaller the cracked area, the better the flexibility.

### [Evaluation Criteria]

S (excellent): No change was observed in the entire protective layer.
A (good): Cracks were observed in less than 1% of the area of the entire protective layer as a reference.
B (acceptable): Cracks were observed in 1% or more and less than 5% of the area of the entire protective layer as a reference.
C (unacceptable): Cracks were observed in 5% or more of the area of the entire protective layer as a reference.

### <Adhesion>

A separator was prepared from the resin composition before acceleration by the method described above, cut into sizes of 25 mm wide×100 mm long, and the separator substrate side of the separator and a stainless steel plate were stuck together with a double-sided adhesive tape. A cellophane tape with a width of 18 mm was attached to the surface on the protective layer-side, and roll-pressure bonded with a load of 1 kg. After standing still for 24 hours at a temperature of 25° C. and a humidity of 50%, one end of the cellophane tape was pulled in a direction of 180°, so that the peel strength was measured with a tensile tester AGS-X (manufactured by Shimadzu Corporation) (peeling speed: 10 mm/min, unit: N/18 mm width). A separator was prepared from the resin composition after acceleration also in the same manner to evaluate the adhesion. The higher the peel strength, the better the adhesion.

### [Evaluation Criteria]

S (excellent): The peel strength is 2.0 N/18 mm or more.
A (good): The peel strength is 1.5 N/18 mm or more and less than 2.0 N/18 mm.
B (acceptable): The peel strength is 1.0 N/18 mm or more and less than 1.5 N/18 mm.
C (unacceptable): The peel strength is less than 1.0 N/18 mm

### <Resistance to Electrolytic Solution 2>

A separator was prepared from the resin composition before acceleration by the method described above. The resulting separator was immersed in a mixture solvent of ethylene carbonate:diethyl carbonate=2:3 (volume ratio) at 50° C. for 72 hours. After the immersion, the separator was washed with methanol, and dried at 25° C. under reduced pressure. The dried separator was cut into sizes of 25 mm wide×100 mm long, and the peel strength of the separator was measured in the same manner as the adhesion evaluation described above. From the peel strength results before and after immersion, the rate of change in peel strength was calculated based on the following formula. For the resin composition after acceleration, a separator was prepared also in the same manner to evaluate the resistance to electrolytic solution. The smaller the rate of change in peel strength, the better the resistance to electrolytic solution.

Rate of change in peel strength (%)=[(Peel strength before immersion)−(Peel strength after immersion)/(Peel strength before immersion)]×100

### [Evaluation Criteria]

S (excellent): Rate of change in peel strength is less than 1%.
A (good): Rate of change in peel strength is 1% or more and less than 3%.
B (acceptable): Rate of change in peel strength is 3% or more and less than 5%.
C (unacceptable): Rate of change in peel strength is 5% or more.

### <Heat Resistance>

A separator was prepared from the resin composition before acceleration by the method described above. The separator was cut into sizes of 100 mm in MD (flow direction)×100 mm in TD (perpendicular direction) to obtain a sample. The sample was inserted in three sheets of paper and left in an oven at 140° C. for 2 hours. After cooling of the samples taken out from the oven to 25° C., the shrinkage rate was calculated based on the following formula. A separator was prepared from the resin composition after acceleration also in the same manner to evaluate the heat resistance. The smaller the shrinkage rate, the better the heat resistance.

$$Sample area ( {mm}^{2} ) = ( MD length of sample ) \times ( TD length of sample )$$

$$Shrinkage rate ( \% ) = [ \text{} 1 - ( Sample area after heating ) / ( Sample area before heating ) ] \times 100$$

### [Evaluation Criteria]

S (excellent): Shrinkage rate is less than 5%.
A (good): The shrinkage rate is 5% or more and less than 10%.
B (acceptable): The shrinkage rate is 10% or more and less than 15%.
C (unacceptable): The shrinkage rate is 15% or more.

### (Non-Aqueous Secondary Battery)

### <Cycle Characteristics>

A laminated non-aqueous secondary battery was prepared from the resin composition before acceleration by the above method. The prepared battery was connected so as to perform a charge/discharge test and was submerged in a thermostat chamber at 50° C. A constant current constant voltage charge (cutoff current: 0.6 mA) was performed at a charge current of 60 mA until the charging end voltage reached 4.2 V, and then a constant current discharge was performed at a discharge current of 60 mA until the discharging end voltage reached 3.0 V, so that the initial discharge capacity was determined. The charge/discharge operation regarded as one cycle was repeated 1200 cycles to calculate the discharge capacity retention ratio (the ratio of the discharge capacity at the 1200th cycle relative to the initial discharge capacity). A battery was prepared from the resin composition after acceleration also in the same manner to evaluate the cycle characteristics. It can be said that the higher the discharge capacity retention rate, the better the cycle characteristics.

### [Evaluation Criteria]

S (excellent): The discharge capacity retention rate is 95% or more.
A (good): The discharge capacity retention rate is 90% or more and less than 95%.
B (acceptable): The discharge capacity retention rate is 85% or more and less than 90%.
C (unacceptable): The discharge capacity retention rate is less than 85%.

TABLE 7

| | | | Separator | | | | | |
|---|---|---|---|---|---|---|---|---|
| | | Resin | Resin | | | | | |
| | | composition | composition | | | Resistance to | | Battery |
| | | Stability over | (before/after | | | electrolytic | Heat | Cycle |
| | Binder | time | acceleration) | Flexibility | Adhesion | solution 2 | resistance | characteristics |
| Example B26 | Example B1 | S | Before | S | S | S | S | S |
| | | — | After | S | S | S | S | S |
| Example B27 | Example B2 | S | Before | S | S | S | S | S |
| | | — | After | S | S | S | S | S |
| Example B28 | Example B3 | A | Before | S | S | S | S | S |
| | | — | After | S | A | A | S | A |
| Example B29 | Example B4 | A | Before | S | S | S | S | S |
| | | — | After | A | A | A | A | A |
| Example B30 | Example B5 | S | Before | S | A | A | A | A |
| | | — | After | S | A | A | A | A |
| Example B31 | Example B6 | A | Before | S | S | S | S | S |
| | | — | After | A | A | A | A | A |
| Example 832 | Example B7 | B | Before | S | S | S | S | S |
| | | — | After | A | A | A | A | A |
| Example B33 | Example B8 | S | Before | S | S | S | S | S |
| | | — | After | S | S | S | S | S |
| Example B34 | Example B9 | A | Before | S | S | S | S | S |
| | | — | After | A | A | A | A | A |
| Example B35 | Example 810 | A | Before | S | S | S | S | S |
| | | — | After | A | B | B | A | A |
| Example B36 | Example 811 | S | Before | S | S | S | S | S |
| | | — | After | S | S | S | S | S |
| Example B37 | Example 812 | S | Before | S | S | S | S | S |
| | | — | After | S | A | A | A | A |
| Example B38 | Example B13 | S | Before | S | A | A | A | A |
| | | — | After | S | A | A | A | A |
| Example B39 | Example 814 | S | Before | S | S | S | S | S |
| | | — | After | S | S | A | S | A |
| Example B40 | Example B15 | S | Before | S | S | A | S | A |
| | | — | After | S | S | A | S | A |
| Example B41 | Example B16 | S | Before | S | S | S | S | S |
| | | — | After | S | S | S | S | S |
| Example B42 | Example B17 | S | Before | A | S | S | S | A |
| | | — | After | A | S | S | S | A |
| Example B43 | Example B18 | S | Before | S | S | S | S | S |
| | | — | After | S | S | S | S | S |
| Example B44 | Example B19 | S | Before | A | A | A | A | A |
| | | — | After | A | A | A | A | A |
| Example B45 | Example B20 | S | Before | S | S | S | S | S |
| | | — | After | S | $ | S | S | S |
| Example B46 | Example B21 | S | Before | S | S | S | S | S |
| | | — | After | S | S | S | S | S |
| Example B47 | Example 822 | S | Before | S | 8 | S | A | A |
| | | — | After | S | S | S | A | A |
| Example B48 | Example 823 | S | Before | S | S | S | S | S |
| | | — | After | S | S | S | S | S |
| Example B49 | Example B24 | S | Before | S | S | S | S | S |
| | | — | After | S | S | S | S | S |
| Example B50 | Example 825 | S | Before | S | S | S | S | S |
| | | — | After | S | S | A | S | A |
| Comparative | Comparative | C | Before | A | A | B | B | A |
| Example B6 | Example B1 | — | After | C | C | C | C | C |
| Comparative | Comparative | C | Before | C | C | C | C | B |
| Example B? | Example B2 | — | After | C | C | C | C | C |
| Comparative | Comparative | B | Before | A | B | B | B | A |
| Example B8 | Example B3 | — | After | B | C | C | C | C |
| Comparative | Comparative | B | Before | A | A | B | B | A |
| Example B9 | Example B4 | — | After | B | B | C | C | C |
| Comparative | Comparative | B | Before | S | B | C | B | C |
| Example B10 | Example B5 | — | After | C | C | C | C | C |

As shown in Table 7, it has been found that the resin composition containing the binder of the present disclosure is excellent in storage stability, and the separator provided with a protective layer formed from the resin composition is very excellent in flexibility, adhesion, resistance to electrolytic solution and heat resistance. Further, it has been found that the electricity storage device of the present disclosure has good cycle characteristics.

The present application claims priority based on Japanese Patent Application No. 2021-141623 filed on Aug. 31, 2021 and Japanese Patent Application No. 2022-065757 filed on Apr. 12, 2022, and the entirety of the disclosures is incorporated herein.

1-18. (canceled)

19. A binder for a non-aqueous secondary battery separator, comprising:
a polymer (A) prepared by polymerization of a monomer mixture comprising a monomer (a1) having an acidic functional group, a monomer (a2) having an amide group, and an alkyl (meth)acrylate monomer (a3); and
a condensation product (B) of a silane compound (b) represented by the following general formula,
wherein the binder has a glass transition temperature of −60 to 60° C.: 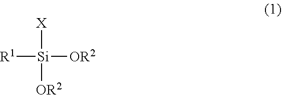
wherein R¹ represents an alkyl group having 1 to 18 carbon atoms, a cycloalkyl group having 1 to 18 carbon atoms, or an aryl group having 1 to 18 carbon atoms, R² represents each independently a methyl group or an ethyl group, and X represents a methyl group, a methoxy group, or an ethoxy group.

20. The binder for a non-aqueous secondary battery separator according to claim 19, wherein the acidic functional group of the monomer (a1) having an acidic functional group is any of a carboxyl group, a sulfonate group, or a phosphate group.

21. The binder for a non-aqueous secondary battery separator according to claim 19, wherein the monomer mixture contains no monomer (a4) having a crosslinkable functional group.

22. The binder for a non-aqueous secondary battery separator according to claim 19, wherein the binder is in a particulate form and has an average particle size of 50 to 500 nm.

23. The binder for a non-aqueous secondary battery separator according to claim 19, wherein the polymer (A) is obtained by emulsion polymerization of the monomer mixture in an aqueous medium in which the silane compound (b) is dissolved.

24. A resin composition for a non-aqueous secondary battery separator, comprising:
the binder for a non-aqueous secondary battery separator according to claim 19; and
an inorganic filler.

25. A non-aqueous secondary battery separator comprising:
a protective layer formed from the resin composition for a non-aqueous secondary battery separator according to claim 24 on at least one surface of a separator substrate.

26. A non-aqueous secondary battery comprising:
the non-aqueous secondary battery separator according to claim 25;
a positive electrode; and
a negative electrode.

27. A method for preparing a binder for a non-aqueous secondary battery separator, comprising:
a step of emulsion polymerizing a monomer mixture in an aqueous medium in which a silane compound (b) represented by the following general formula is dissolved, to thereby prepare a condensation product (B) of a silane compound (b) and a polymer (A),
wherein the monomer mixture contains a monomer (a1) having an acidic functional group, a monomer (a2) having an amide group, and an alkyl (meth)acrylate monomer (a3), and a glass transition temperature of the binder is −60 to 60° C.: 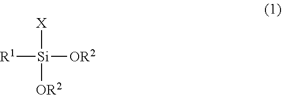
wherein R¹ represents an alkyl group having 1 to 18 carbon atoms, a cycloalkyl group having 1 to 18 carbon atoms, or an aryl group having 1 to 18 carbon atoms, R² each independently represents a methyl group or an ethyl group, and X represents a methyl group, a methoxy group, or an ethoxy group.

28. An electricity storage device comprising:
a separator substrate provided with at least one protective layer between a pair of electrodes,
wherein the protective layer includes a polymer (C) of an ethylenically unsaturated monomer (c), and a silane compound, and the silane compound has no ethylenically unsaturated group but has an alkyl group having 3 to 12 carbon atoms.

29. The electricity storage device according to claim 28, wherein the silane compound includes a condensate (D) of an alkoxy monosilane compound (d) having no ethylenically unsaturated group but having an alkyl group having 3 to 12 carbon atoms.

30. The electricity storage device according to claim 29, wherein a complete hydrolysate of the alkoxy monosilane compound (d) has an octanol/water partition coefficient (log Kow) of −1.5 to 6 at 25° C.

31. The electricity storage device according to claim 28, wherein the ethylenically unsaturated monomer (c) comprises at least one selected from the group consisting of a monomer (c1) having an acidic group and a monomer (c2) having an amide group.

32. The electricity storage device according to claim 28, wherein the protective layer further comprises an inorganic filler.

33. The binder for a non-aqueous secondary battery separator according to claim 20, wherein the monomer mixture contains no monomer (a4) having a crosslinkable functional group.

34. The binder for a non-aqueous secondary battery separator according to claim 20, wherein the binder is in a particulate form and has an average particle size of 50 to 500 nm.

35. The binder for a non-aqueous secondary battery separator according to claim 20, wherein the polymer (A) is obtained by emulsion polymerization of the monomer mixture in an aqueous medium in which the silane compound (b) is dissolved.

36. The binder for a non-aqueous secondary battery separator according to claim 21, wherein the polymer (A) is obtained by emulsion polymerization of the monomer mixture in an aqueous medium in which the silane compound (b) is dissolved.

37. The electricity storage device according to claim 29, wherein the ethylenically unsaturated monomer (c) comprises at least one selected from the group consisting of a monomer (c1) having an acidic group and a monomer (c2) having an amide group.

38. The electricity storage device according to claim 29, wherein the protective layer further comprises an inorganic filler.
